(19) United States
(12) Patent Application Publication
(10) Pub. No.: US 2022/0198539 A1
(43) Pub. Date: Jun. 23, 2022

(54) CHECKOUT SYSTEM AND CHECKOUT METHOD

(71) Applicant: PANASONIC INTELLECTUAL PROPERTY MANAGEMENT CO., LTD., Osaka (JP)

(72) Inventors: Koji HORIUCHI, Fukuoka (JP); Yoshiteru TANAKA, Fukuoka (JP); Hiroto TOMITA, Fukuoka (JP)

(73) Assignee: PANASONIC INTELLECTUAL PROPERTY MANAGEMENT CO., LTD., Osaka (JP)

(21) Appl. No.: 17/559,275

(22) Filed: Dec. 22, 2021

(30) Foreign Application Priority Data
Dec. 23, 2020 (JP) 2020-213532
Sep. 3, 2021 (JP) 2021-143998

(51) Int. Cl. G06Q 30/06; G06Q 30/00; G06V 40/16

(52) U.S. Cl. CPC G06Q 30/0609; G06V 40/172; G06Q 30/0637; G06Q 30/018

(57) ABSTRACT

A checkout system implemented by one or more computers includes: a product detection unit configured to detect a product to be purchased; a detection unit configured to detect whether the product detected by the product detection unit is a restricted product; a camera configured to capture a face image of a customer in a case in which the restricted product is detected; an age estimation unit configured to perform age estimation processing of the customer based on the face image; and a determination unit configured to determine whether the customer is allowed to purchase the restricted product based on an estimated age. The determination unit determines a threshold of the estimated age for determining whether the restricted product is allowed to be purchased based on an environment of a store that sells the restricted product or a situation of the customer.

### CROSS-REFERENCE TO RELATED APPLICATIONS

This application is based on and claims the benefit of priority of Japanese Patent Application No. 2020-213532 filed on Dec. 23, 2020 and Japanese Patent Application No. 2021-143998 filed on Sep. 3, 2021, the entire contents of which are incorporated herein by reference.

### FIELD

The present disclosure relates to a checkout system and a checkout method.

### BACKGROUND

JP-A-2019-168762 discloses a checkout system that generates a face image of a customer, estimates an age of the customer based on the face image, and determines whether the estimated age of the customer satisfies an age condition when a product registration by the customer is received and a registration of a restricted product is detected. When the checkout system determines that the age condition is satisfied, the checkout system performs checkout processing of the registered product. When the checkout system determines that the age condition is not satisfied, the checkout system transmits registration information of the registered product or customer information for estimating the age of the customer to another device.

### SUMMARY

In an operation of the checkout system, an environment in which the checkout system or a camera is installed may not be suitable for capturing the face image used for age estimation. In the face image captured in such an environment, for example, a face of the customer may be in a backlight state due to lighting in a store, or image quality may be deteriorated due to afternoon sun, such as the face of the customer is overexposed. When the checkout system performs the age estimation using the face image with the deteriorated image quality, age estimation accuracy is reduced, and the checkout system may erroneously determine that the customer can purchase a restricted product.

The present disclosure has been made in view of the above-described circumstances, and an object thereof is to provide a checkout system and a checkout method that support checkout of a restricted product by a customer by more adaptively performing age estimation processing of the customer according to an environment of a store or a situation of the customer.

The present disclosure provides a checkout system implemented by one or more computers, the checkout system including: a product detection unit configured to detect a product to be purchased; a detection unit configured to detect whether the product detected by the product detection unit is a restricted product; a camera configured to capture a face image of a customer in a case in which the restricted product is detected by the detection unit; an age estimation unit configured to perform age estimation processing of the customer based on the face image captured by the camera; and a determination unit configured to determine whether the customer is allowed to purchase the restricted product based on an estimated age, wherein the determination unit determines a threshold of the estimated age for determining whether the restricted product is allowed to be purchased based on an environment of a store that sells the restricted product or a situation of the customer.

Further, the present disclosure provides a checkout method implemented by one or more computers, the checkout method including: detecting a product to be purchased; detecting whether the product is a restricted product; capturing a face image of a customer in a case in which the restricted product is detected; performing age estimation processing of the customer based on the captured face image; determining whether the customer is allowed to purchase the restricted product based on the estimated age estimated; and determining a threshold of the estimated age for determining whether the restricted product is allowed to purchased based on an environment of a store that sells the restricted product or a situation of the customer.

According to the present disclosure, it is possible to more adaptively perform the age estimation processing of the customer according to the environment of the store or the situation of the customer, and support the checkout of the restricted product by the customer.

### BRIEF DESCRIPTION OF DRAWINGS

FIG. 1 is a diagram showing an example of a use case of a checkout system according to a first embodiment.

FIG. 2 is a block diagram showing an example of an internal configuration of the checkout system according to the first embodiment.

FIG. 3 is a block diagram showing an example of an internal configuration of a salesperson confirmation system according to the first embodiment.

FIG. 4 is a table showing an example of minor determination conditions.

FIG. 5 is a table showing an example of an estimated time.

FIG. 6A is a flowchart showing a first operation procedure example (biometric settlement) of the checkout system according to the first embodiment.

FIG. 6B is a flowchart showing a second operation procedure example (biometric settlement) of the checkout system according to the first embodiment.

FIG. 6C is a flowchart showing a third operation procedure example (biometric settlement) of the checkout system according to the first embodiment.

FIG. 7A is a flowchart showing a fourth operation procedure example (cashless settlement) of the checkout system according to the first embodiment.

FIG. 7B is a flowchart showing a fifth operation procedure example (cashless settlement) of the checkout system according to the first embodiment.

FIG. 8 is a flowchart showing a sixth operation procedure example (cash settlement) of the checkout system according to the first embodiment.

### DETAILED DESCRIPTION

(Introduction to Present Disclosure)

In recent years, settlement methods that can be used for a checkout system (for example, a register, or a self-register) have increased. Examples thereof include cash settlement, biometric settlement by biometric authentication, and cashless settlement using a credit card, a smartphone, or the like. The checkout system performs checkout by any settlement method designated by the customer. However, when using a settlement method in which age information of the customer is registered in advance, it is not always necessary to estimate the age of the customer based on the face image. However, in the checkout system in the related art, it is not possible to determine whether it is necessary to estimate the age in accordance with the settlement method designated by the customer.

In an operation of the checkout system, an environment in which the checkout system or a camera is installed may not be suitable for capturing the face image used for age estimation. In the face image captured in such an environment, for example, a face of the customer may be in a backlight state due to lighting in a store, or image quality may be deteriorated due to afternoon sun, such as the face of the customer is overexposed. When the checkout system performs the age estimation using the face image with the deteriorated image quality, age estimation accuracy is reduced, and the checkout system may erroneously determine that the customer can purchase a restricted product.

Hereinafter, an embodiment in which a configuration and an operation of a checkout system and a checkout method according to the present disclosure are specifically disclosed will be described in detail with reference to the drawings as appropriate. However, an unnecessarily detailed description may be omitted. For example, a detailed description of a well-known matter or a repeated description of substantially the same configuration may be omitted. This is to avoid unnecessary redundancy in the following description and to facilitate understanding of those skilled in the art. The accompanying drawings and the following descriptions are provided for those skilled in the art to have a thorough understanding of the present disclosure, and are not intended to limit a subject matter recited in the claims.

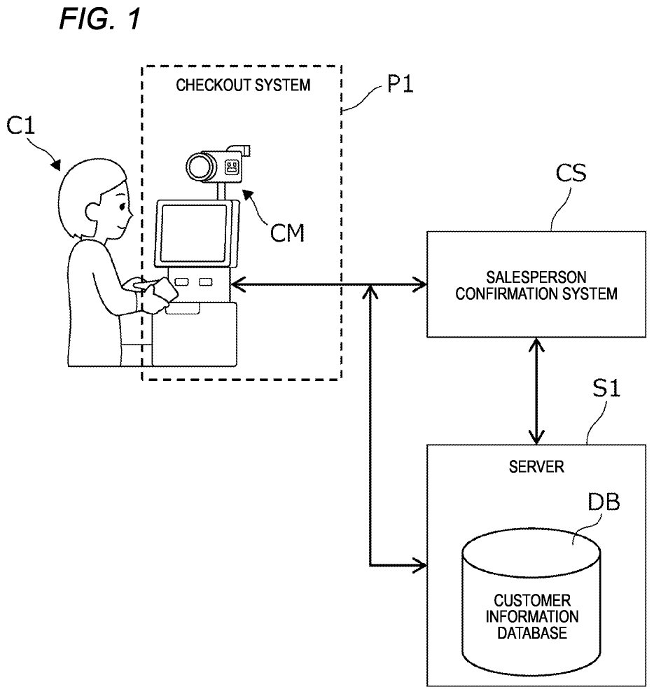

First, a use case of a checkout system P1 according to a first embodiment will be described with reference to FIG. 1. FIG. 1 is a diagram showing an example of the use case of the checkout system P1 according to the first embodiment. The checkout system P1 shown in FIG. 1 is an example, and the checkout system P1 is not limited thereto. For example, the checkout system P1 may be configured integrally with a salesperson confirmation system CS, or may be configured integrally with a server S1 including a customer information database DB. Further, the checkout system P1 may be configured integrally with the salesperson confirmation system CS and the server S1.

The checkout system P1 is a so-called register, a self-register, or the like, and is installed in a store such as a supermarket, a convenience store, a retail store, a commercial facility, or the like. The checkout system P1 is implemented by one or more computers, and enables checkout and settlement of each of one or more products purchased by a customer C1. The checkout system P1 can execute checkout processing by a plurality of types of settlement methods such as the biometric settlement, the cashless settlement, and the cash settlement, and executes the settlement processing based on any settlement method designated (selected) by the customer C1. The checkout system P1 is connected to the salesperson confirmation system CS and the server S1 so as to be capable of wired communication or wireless communication, and executes data transmission and reception. Here, the wireless communication is communication via a wireless local area network (LAN) such as Wi-Fi (registered trademark). The checkout system P1 may be connected to another terminal device (for example, a ticket PIA (registered trademark), Loppi (registered trademark), or the like capable of purchasing a product, issuing a coupon, or reserving or paying a ticket) installed in the same store so as to be capable of data communication, and may be capable of acquiring information (for example, the age information) related to the customer who uses the store.

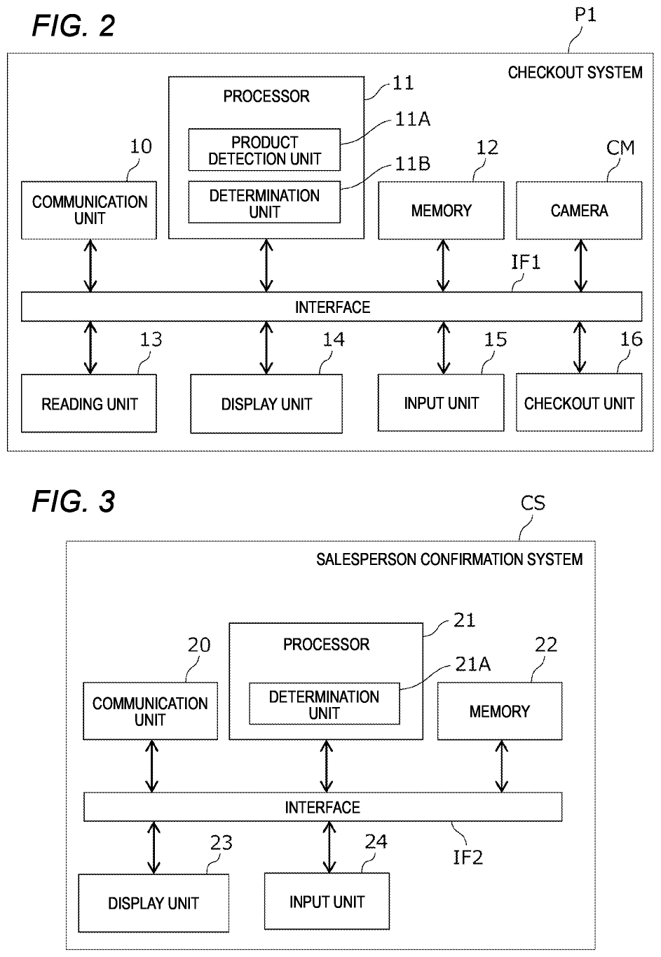

The checkout system P1 includes a camera CM installed at a position capable of capturing a face image of the customer C1 who checks out the product, a reading unit 13 (see FIG. 2) such as a bar code reader for reading product information from a two-dimensional barcode, a QR code (registered trademark), or the like, a display unit 14 (see FIG. 2) capable of displaying a screen related to the checkout and the settlement, an input unit 15 (see FIG. 2) capable of receiving an input operation by the customer C1, and the like.

When the checkout system P1 detects the product (for example, liquor, or cigarette) (hereinafter, referred to as a “restricted product”) having an age limitation for purchase among one or more products purchased by the customer C1, the checkout system P1 determines whether the customer C1 can purchase the restricted product. Specifically, the checkout system P1 determines a purchase permission process for determining whether the customer C1 is at an age at which the customer C1 can purchase the restricted product based on the settlement method designated by the customer C1. The checkout system P1 determines whether the customer C1 is at the age at which the customer C1 can purchase the restricted product by executing processing based on the determined purchase permission process. When it is determined that the customer C1 is at the age at which the customer C1 can purchase the restricted product, the checkout system P1 proceeds to the checkout processing of one or more checked out products.

Here, the purchase permission process is a process to be executed in minor determination processing determined based on the settlement method designated by the customer C1 and a determination result as to whether the age information of the customer C1 can be acquired based on the settlement method. As processing for determining whether the customer C1 is at the age at which the customer C1 can purchase the restricted product, the purchase permission process is determined, based on the settlement method and the determination result of whether the age information of the customer C1 cannot be acquired, by including any one of a plurality of processing such as age estimation processing based on the face image of the customer C1 captured by the camera CM, optical character recognition/reader (OCR) processing for a certificate (for example, a driver license, an individual number card, a health insurance card, etc.) in which the age information or information on a date of birth of the customer C1 is described, and visual confirmation request processing by a salesperson.

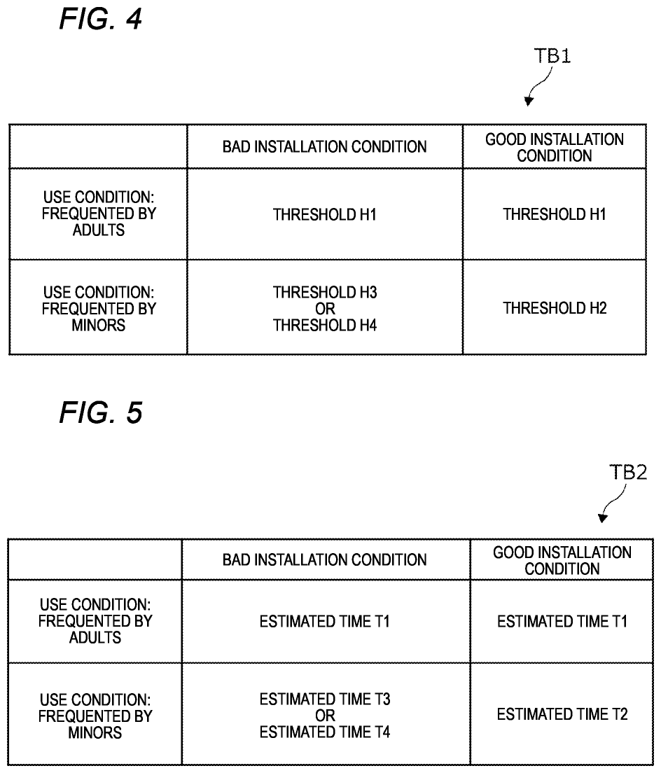

The checkout system P1 determines a determination condition (hereinafter, referred to as the “minor determination condition”) for determining whether the customer C1 can purchase the restricted product, and determines an estimated time of the age estimation processing for estimating the age of the customer C1 based on the face image of the customer C1. The minor determination condition and the estimated time are determined based on an installation condition under which the checkout system P1 is installed and a condition related to the customer who uses the store (hereinafter, referred to as “use condition of the store”). The minor determination condition and the estimated time will be described in detail with reference to FIGS. 4 and 5, which will be described later. The installation condition under which the checkout system P1 is installed and the use condition of the store are examples of the environment of the store that sells the restricted product.

The salesperson confirmation system CS is operated by the salesperson or an administrator of the store in which the checkout system P1 is installed, and is implemented by one or more computers. The salesperson confirmation system CS is connected to the checkout system P1 and the server S1 so as to be capable of the wired communication or the wireless communication, and executes the data transmission and reception. The salesperson confirmation system CS displays product information (for example, price information of the product, a product name, and information indicating whether the product is the restricted product) of each product purchased by the customer C1, information related to an age confirmation result, and the like. Here, the age confirmation result is the age information of the customer C1, information on the estimated age of the customer C1 (hereinafter, referred to as “estimated age information”), or the like. The salesperson confirmation system CS may be connected to another terminal device (for example, the ticket PIA (registered trademark), Loppi (registered trademark), or the like capable of purchasing the product, issuing the coupon, or reserving or paying the ticket) installed in the same store so as to be capable of the data communication, and may be capable of acquiring information (for example, the age information) related to the customer who uses the store.

The server S1 is connected to the checkout system P1 and the salesperson confirmation system CS so as to be capable of the wired communication or the wireless communication, and executes the data transmission and reception. The server S1 stores (registers) an ID (identification) capable of identifying a settlement medium used for settlement (for example, a body of the customer C1 (face, finger, hand, iris, or the like), an IC card, a smartphone, a credit card, or a debit card) and the customer information of the customer C1 in association with each other in the customer information database DB. Here, the customer information of the customer C1 is, for example, any one of the face image of the customer C1, the information on the date of birth of the customer C1, the age information, or biometric information for biometric authentication of the customer C1 (specifically, the biometric information based on the face, fingerprint, vein, and iris of the customer C1). The server S1 extracts, based on the ID of the settlement medium transmitted from the checkout system P1 or the salesperson confirmation system CS and a control command requesting the customer information, the customer information associated with the ID of the settlement medium, and transmits the customer information to the checkout system P1 or the salesperson confirmation system CS.

In the first embodiment, in order to simplify the description, an example in which the server S1 is configured to include one customer information database DB is shown, whereas the server S1 is not limited thereto. The server S1 may be configured to include each of a plurality of customer information databases, or may be configured separately from the customer information database DB. The number of the servers S1 and the number of the customer information databases DB are not limited to one, and may be two or more. For example, the server S1 and the customer information database DB may be provided for each company that manages the settlement medium.

Next, an internal configuration of the checkout system P1 according to the first embodiment will be described with reference to FIG. 2. FIG. 2 is a block diagram showing an example of the internal configuration of the checkout system P1 according to the first embodiment.

The checkout system P1 includes a communication unit 10, a processor 11, a memory 12, the reading unit 13, the display unit 14, the input unit 15, a checkout unit 16, and the camera CM. The reading unit 13, the display unit 14, the input unit 15, the checkout unit 16, or the camera CM may not be configured integrally with the checkout system P1, but may be configured separately from the checkout system P1.

The communication unit 10 as an example of an acquisition unit is connected to a communication unit 20 in the salesperson confirmation system CS and a communication unit (not shown) in the server S1 so as to be able to perform the wired communication or the wireless communication, and performs the data transmission and reception.

The processor 11 is configured using, for example, a central processing unit (CPU) or a field programmable gate array (FPGA), and performs various processing and control in cooperation with the memory 12. Specifically, the processor 11 refers to a program and data held in the memory 12, and executes the program to implement functions of units. Here, the units are, for example, a product detection unit 11A, and a determination unit 11B.

The product detection unit 11A as an example of a detection unit outputs information (for example, the price information, and the product name) related to the product read by the reading unit 13 to the display unit 14 and causes the display unit 14 to display the information. The product detection unit 11A acquires the product information with reference to the memory 12 based on identification information of the product read by the reading unit 13, and detects whether each of one or more products purchased by the customer C1 includes the restricted product.

When the restricted product is detected by the product detection unit 11A, the determination unit 11B as an example of an age estimation unit determines the purchase permission process based on the settlement method designated by the customer C1. The determination unit 11B determines whether the restricted product can be purchased based on the determined purchase permission process, and executes the checkout processing by the settlement method designated by the customer C1. The determination unit 11B generates and outputs the control command necessary for control of each of the reading unit 13, the display unit 14, the input unit 15, the checkout unit 16, and the camera CM based on the determined purchase permission process.

The determination unit 11B associates the product information of each of one or more products purchased by the customer C1 with the age confirmation result obtained by execution of the purchase permission process, and transmits the product information and the age confirmation result to the salesperson confirmation system CS via the communication unit 10.

The memory 12 includes a storage device including a semiconductor memory such as a random access memory (RAM) and a read only memory (ROM) and a storage device such as a solid state drive (SSD) or an HDD. The memory 12 stores each piece of the product information of all products sold in the store or the like in which the checkout system P1 is installed.

The memory 12 may not store each piece of the product information of all products. In such a case, the product detection unit 11A in the checkout system P1 generates the control command for requesting the transmission of the product information of the product read by the reading unit 13, and transmits the control command to the salesperson confirmation system CS. The product detection unit 11A displays the product information of the product transmitted from the salesperson confirmation system CS on the display unit 14.

The reading unit 13 scans the two-dimensional barcode, the QR code (registered trademark), or the like attached to the product to read the identification information of the product. The reading unit 13 outputs the identification information of the read product to the product detection unit 11A.

The reading unit 13 reads the ID of the settlement medium used for the settlement. The reading unit 13 generates a control command for requesting owner information of the settlement medium (that is, the customer information of the customer C1), associates the generated control command with the ID of the read settlement medium, and transmits the control command and the ID of the read settlement medium to the server S1 via the communication unit 10. The reading unit 13 outputs the owner information of the settlement medium transmitted from the server S1 (that is, the customer information of the customer C1) to the determination unit 11B.

The display unit 14 is configured using, for example, a display such as a liquid crystal display (LCD) or an organic electroluminescence (EL). The display unit 14 displays the product information, checkout information, a list of settlement methods, and the like output from the processor 11.

The input unit 15 is a user interface configured by using, for example, a touch panel, or buttons. The input unit 15 converts a received operation of the customer C1 into an electrical signal (control command) and outputs the electrical signal to the processor 11. When the input unit 15 is configured using the touch panel, the input unit 15 is configured integrally with the display unit 14.

The checkout unit 16 executes the checkout processing of all the products read by the reading unit 13, and executes the checkout processing based on the settlement method designated by the customer C1.

The camera CM as an example of the acquisition unit is, for example, a solid-state imaging element of a charged-coupled device (CCD) or a complementary metal oxide semiconductor (CMOS), and converts an optical image formed on a imaging surface into the electrical signal.

An interface IF1 connects each unit and each functional configuration configuring the checkout system P1 so as to be able to communicate with each other, and inputs and outputs various kinds of data.

Next, an internal configuration of the salesperson confirmation system CS will be described with reference to FIG. 3. FIG. 3 is a block diagram showing an example of the internal configuration of the salesperson confirmation system CS according to the first embodiment.

An example in which the salesperson confirmation system CS shown in FIG. 3 can execute determination processing of the purchase permission process, determination processing of determining whether the customer C1 can purchase the restricted product based on the purchase permission process, and the checkout processing will be described. In such a case, the salesperson confirmation system CS is connected to each of the processor 11, the reading unit 13, the checkout unit 16, and the camera CM in the checkout system P1 via the communication unit 10 of the checkout system P1 such that the data can be transmitted and received therebetween. The salesperson confirmation system CS includes the communication unit 20, a processor 21, a memory 22, a display unit 23, and an input unit 24.

The communication unit 20 as an example of the acquisition unit is connected to the communication unit 10 in the checkout system P1 and the communication unit (not shown) in the server S1 so as to be able to perform the wired communication or the wireless communication, and performs the data transmission and reception.

The processor 21 is configured by using, for example, a CPU or an FPGA, and cooperates with the memory 22 so as to perform various processing and control. Specifically, the processor 21 refers to a program and data held in the memory 22, and executes the program to implement functions of units. Here, each unit is, for example, a determination unit 21A.

When the determination unit 21A acquires the control command indicating that the restricted product is detected from the product detection unit 11A in the checkout system P1, the determination unit 21A determines the purchase permission process based on the settlement method designated by the customer C1. The determination unit 21A determines whether the restricted product can be purchased based on the determined purchase permission process, and executes the checkout processing by the settlement method designated by the customer C1. The determination unit 21A generates and outputs the control command necessary for controlling the checkout system P1, the display unit 23, or the input unit 24 based on the determined purchase permission process.

The determination unit 21A stores the one or more pieces of product information transmitted from the checkout system P1 and the age confirmation result obtained by the execution of the purchase permission process in the memory 22 in association with each other, and outputs the one or more pieces of product information and the age confirmation result to the display unit 23 to display the product information and the age confirmation result.

The memory 22 includes a storage device including a semiconductor memory such as a RAM and a storage device such as an SSD or an HDD. The memory 22 stores each piece of the product information of all products sold in the store or the like in which the checkout system P1 is installed.

The display unit 23 is configured using, for example, a display such as an LCD or an organic EL. The display unit 23 displays the product information, the checkout information, the age confirmation result, or the like output from the processor 21.

The input unit 24 is a user interface configured by using, for example, a touch panel, buttons, or a keyboard. The input unit 24 converts the received operation of the salesperson or the customer C1 into the electrical signal (control command) and outputs the electrical signal to the processor 21. When the input unit 24 is configured using the touch panel, the input unit 24 is integrally configured with the display unit 23.

An interface IF2 connects each unit and each functional configuration configuring the salesperson confirmation system CS so as to be able to communicate with each other, and inputs and outputs various kinds of data.

The minor determination condition will be described with reference to FIG. 4. FIG. 4 is a table TB1 showing an example of the minor determination condition. In the following description, a method of determining the minor determination condition by the checkout system P1 will be described, whereas it is needless to say that the minor determination condition may be determined by the salesperson confirmation system CS. In the description of FIG. 4, a description of a predetermined installation condition under which the checkout system P1 is to be installed and a use condition of the store (that is, a predetermined value of a ratio of minors in a customer group using the store) will be omitted and will be described later. The ratio of minors in the customer group using the store is an example of the environment of the store that sells the restricted product.

The minor determination condition shown in FIG. 4 is an estimated age threshold for determining whether the customer C1 is a minor based on the estimated age information of the customer C1. The minor determination condition is determined based on the installation condition of the checkout system P1 and the use condition of the store in which the checkout system P1 is installed. The minor determination condition is set by either the checkout system P1 or the salesperson confirmation system CS. The minor determination condition may be determined for each customer, may be determined for each predetermined period (for example, one day, one week, or one month), or may be designated at any timing by a salesperson operation via the input unit in the checkout system P1 or the salesperson confirmation system CS.

As shown in the table TB1, when it is determined that the installation condition of the checkout system P1 does not satisfy the predetermined installation condition and a ratio of minors occupying the customer group using the store in which the checkout system P1 is installed is less than the predetermined value, the checkout system P1 determines the minor determination condition to be a threshold H1.

When it is determined that the installation condition of the checkout system P1 satisfies the predetermined installation condition and the ratio of minors occupying the customer group using the store in which the checkout system P1 is installed is less than the predetermined value, the checkout system P1 determines the minor determination condition to be the threshold H1.

When it is determined that the installation condition of the checkout system P1 does not satisfy the predetermined installation condition and the ratio of minors occupying the customer group using the store in which the checkout system P1 is installed is equal to or greater than the predetermined value, the checkout system P1 determines the minor determination condition to be either a threshold H3 or a threshold H4. Specifically, when it is determined that the installation condition of the checkout system P1 does not satisfy the predetermined installation condition, that the ratio of minors occupying the customer group using the store in which the checkout system P1 is installed is equal to or greater than the predetermined value, and that a current minor determination condition is the threshold H1 or a threshold H2, the checkout system P1 determines the minor determination condition to be the threshold H3. When the current minor determination condition is the threshold H3, the checkout system P1 determines the minor determination condition to be the threshold H4 higher than the threshold H3.

When it is determined that the installation condition of the checkout system P1 satisfies the predetermined installation condition and the ratio of minors using the store in which the checkout system P1 is installed is equal to or greater than the predetermined value, the checkout system P1 determines the minor determination condition to be the threshold H2.

Each of the thresholds H1 to H4 is any estimated age having a magnitude relationship of threshold H1 threshold H2 threshold H3 threshold H4, and may be set by the salesperson. For example, the thresholds H1 to H4 are set such that the threshold H1=25 years old, the threshold H2=30 years old, the threshold H3=30 years old, and the threshold H4=35 years old, respectively. The threshold H1 is preferably set to an age larger than 20 years in order to more reliably prevent the restricted product from being sold to the minor, and may be set to an age equal to or larger than 20 years. The above-described minor determination condition shows an example in which the threshold H2=the threshold H3, whereas different values may be used. Further, an upper limit value (for example, 40 years old, or 45 years old) may be set as the minor determination condition.

When it is determined that the estimated age of the customer C1 is equal to or greater than the threshold determined as the minor determination condition based on the determined minor determination condition (threshold), the checkout system P1 determines that the customer C1 is an adult. On the other hand, when it is determined that the estimated age of the customer C1 is not equal to or greater than the threshold determined as the minor determination condition, the checkout system P1 determines that the customer C1 is the minor.

Further, when it is determined that wearing of a mask is increasing based on the captured face images of the plurality of customers, the checkout system P1 may uniformly determine the minor determination condition as the threshold H4 regardless of whether the installation condition of the checkout system P1 is satisfied. Accordingly, when the checkout system P1 executes the age estimation processing of the customer C1 using the face image in which a part of the face is hidden by the mask, since it is possible to determine a higher estimated age (threshold) as the minor determination condition, it is possible to more reliably prevent the purchase of the restricted product due to the minor. Even when the age estimation processing of the customer C1 is executed using a face image in which a part of the face is hidden due to whether wearing sunglasses, whether wearing a hat, or the like in addition to whether wearing a mask, it is possible to uniformly determine the minor determination condition as the threshold H4 and prevent the purchase of the restricted product due to the minor. Whether to wear the mask, whether to wear the sunglasses, and whether to wear the hat are factors that determine a degree of exposure of the face of the customer.

In the example shown in the first embodiment, the number of types of thresholds determined as the minor determination condition is four, and may be five or more. For example, when it is determined that the installation condition of the checkout system P1 is not satisfied, the ratio of minors using the store in which the checkout system P1 is installed is equal to or greater than the predetermined value, and the current minor determination condition is the threshold H4, the checkout system P1 may determine a threshold H5 of the estimated age higher than the threshold H4 as the minor determination condition. Accordingly, the checkout system P1 can more reliably prevent the purchase of the restricted product due to the minor.

The estimated time in the age estimation processing will be described with reference to FIG. 5. FIG. 5 is a table TB2 showing an example of the estimated time. The estimated time shown in FIG. 5 is an example, and the estimated time is not limited thereto. In the following description, a method of determining the estimated time by the checkout system P1 will be described, whereas it is needless to say that the estimated time may be determined by the salesperson confirmation system CS. In the description of FIG. 5, a description of a predetermined installation condition under which the checkout system P1 is to be installed and a use condition of the store (that is, a predetermined value of a ratio of minors in a customer group using the store) will be omitted and will be described later.

The estimated time shown in FIG. 5 is a time (hereinafter, referred to as the “estimated time”) for executing the age estimation processing in the minor determination processing of determining whether the customer C1 is the minor. The estimated time is determined based on the installation condition of the checkout system P1 and the use condition of the store in which the checkout system P1 is installed. The estimated time is determined by either the checkout system P1 or the salesperson confirmation system CS. The estimated time may be changed for each customer, may be changed for each predetermined period (for example, one day, one week, or one month), or may be changed at any timing by the salesperson operation via the input unit in the checkout system P1 or the salesperson confirmation system CS.

The estimated time in the first embodiment may be a processing time of the age estimation processing per customer, or may be the number of face images for which the age estimation processing per customer is executed (that is, the number of times of execution of the age estimation processing per customer). In the description of FIG. 5, an example in which the estimated time is the number of face images for which the age estimation processing per customer is executed will be described, whereas it is needless to say that the estimated time may be the time of the age estimation processing per customer.

As shown in the table TB2, when it is determined that the installation condition of the checkout system P1 does not satisfy the predetermined installation condition, and the ratio of minors in the customer group using the store in which the checkout system P1 is installed is less than the predetermined value, the checkout system P1 determines an estimated time T1 as the estimated time.

When it is determined that the installation condition of the checkout system P1 satisfies the predetermined installation condition and the ratio of minors in the customer group using the store in which the checkout system P1 is installed is determined to be less than the predetermined value, the checkout system P1 determines the estimated time T1.

When it is determined that the installation condition of the checkout system P1 does not satisfy the predetermined installation condition and the ratio of minors in the customer group using the store in which the checkout system P1 is installed is equal to or greater than the predetermined value, the checkout system P1 determines either an estimated time T3 or an estimated time T4. Specifically, when it is determined that the installation condition of the checkout system P1 does not satisfy the predetermined installation condition, that the ratio of minors in the customer group using the store in which the checkout system P1 is installed is equal to or greater than the predetermined value, and that the current estimated time is the estimated time T1 or an estimated time T2, the checkout system P1 determines the estimated time T3. When it is determined that the current estimated time is the estimated time T3, the checkout system P1 determines the estimated time T4 longer than the estimated time T3.

When it is determined that the installation condition of the checkout system P1 satisfies the predetermined installation condition, and the ratio of the minor in the customer group using the store in which the checkout system P1 is installed is determined to be equal to or greater than the predetermined value, the checkout system P1 determines the estimated time T2.

Each of the estimated times T1 to T4 is any value having a magnitude relationship of estimated time T1 estimated time T2 estimated time T3 estimated time T4, and may be determined by the salesperson. For example, the estimated times T1 to T4 are determined as follows: estimated time T1=age estimation processing time for one face image; estimated time T2=age estimation processing time for two face images; estimated time T3=age estimation processing time for three face images; and estimated time T4=age estimation processing time for four face images. The estimated time Ti may be equal to or longer than the age estimation processing time for one face image. An upper limit value (for example, the age estimation processing time for five face images, or the age estimation processing time for six face images) may be determined as the estimated time. As described above, the checkout system P1 can improve age estimation accuracy by executing the age estimation processing based on the determined estimated time.

Based on the determined estimated time, the checkout system P1 increases or decreases the number of face images of the customer C1 captured by the camera CM, selects a face image to be subjected to the age estimation processing among a plurality of captured face images, and adjusts an age estimation processing time per face image. When executing the age estimation processing using each of two or more face images, the checkout system P1 calculates an average value, a median value, a maximum value, a minimum value, a mode value, or the like of the estimated age information indicated by each of age estimation results, and outputs the average value, the median value, the maximum value, the minimum value, the mode value, or the like as the age estimation result of the customer C1. Accordingly, the checkout system P1 can improve the age estimation accuracy.

In the example shown in the first embodiment, five or more estimated times may be set as the estimated time. For example, when it is determined that the installation condition of the checkout system P1 does not satisfy the predetermined installation condition, that the ratio of minors in the customer group using the store in which the checkout system P1 is installed is determined to be equal to or greater than the predetermined value, and that the current estimated age is the estimated time T4, the checkout system P1 may determine an estimated time T5 that is further longer than the estimated time T4. Accordingly, the checkout system P1 can more reliably prevent the purchase of the restricted product due to the minor.

Further, when it is determined that the wearing of the mask is increasing based on the captured face images of the plurality of customers, the checkout system P1 may uniformly determine the age estimation processing time as the estimated time T4 regardless of whether the installation condition of the checkout system P1 is satisfied. Accordingly, even when the checkout system P1 executes the age estimation processing of the customer C1 using the face image in which a part of the face is hidden by the mask, it is possible to improve the age estimation accuracy by increasing the time of the age estimation processing. The age estimation processing time may be uniformly determined as the estimated time T4 regardless of whether the installation condition of the checkout system P1 is satisfied even when it is determined that the wearing of the sunglasses is increased or the wearing of the hat is increased in addition to the increase in the wearing of the mask. Accordingly, the time for the age estimation processing can be increased and the age estimation accuracy can be improved, as in the case where the mask is worn.

As described above, for example, when it is determined that the ratio of minors in the customer group of the store is equal to or greater than the predetermined value as the use condition of the store, the checkout system P1 executes the age estimation processing twice or more or executes the age estimation processing over a longer period of time. Accordingly, the checkout system P1 can further improve the age estimation accuracy by executing the age estimation processing a plurality of times or over a longer period of time, and can more reliably prevent the purchase of the restricted product due to the minor.

Here, the installation condition of the checkout system P1 for determining the minor determination condition (threshold) and the estimated time, and the use condition of the store will be described.

First, the installation condition of the checkout system P1 will be described. Here, the installation condition of the checkout system P1 is, in other words, a condition related to an environment in which the camera CM is installed or a condition for determining whether the checkout system P1 is suitable for the age estimation processing of the customer C1 based on the face image captured by the camera CM. The checkout system P1 analyzes the face image captured by the camera CM, and analyzes the image quality of the face image, a direction of the face of the customer C1 appearing in the face image, and the like. The checkout system P1 determines that the installation condition is bad when the installation condition of the checkout system P1 is not satisfied, and determines that the installation condition is good when the installation condition of the checkout system P1 is satisfied. The environment in which the camera CM is installed is an example of the environment of the store that sells the restricted product.

Specifically, the checkout system P1 analyzes the face image and determines whether there is deterioration in the image quality such as the backlight in the face image, overexposure in the face image, or too dark in the face image. When it is determined, based on an analysis result of the face image, that there is the deterioration in the image quality such as the backlight in the face, the overexposure in the face image, or too dark in the face image, the checkout system P1 determines that the installation condition of the checkout system P1 is not satisfied. Accordingly, the checkout system P1 can determine the minor determination condition or the estimated time of the age estimation processing based on the image quality of the face image.

Therefore, when an age higher than an actual age of the customer C1 is estimated by the age estimation processing using the face image of which the image quality is deteriorated (that is, unsuitable for the age estimation processing), the checkout system P1 can more reliably prevent the purchase of the restricted product due to the minor by the determined minor determination condition. When the checkout system P1 determines, based on the analysis result of the face image of the customer C1, that the face image is not suitable for the age estimation processing (that is, the installation condition of the checkout system P1 is not satisfied), for example, the face image is too dark, the checkout system P1 executes the age estimation processing a plurality of times or over a longer period of time. Accordingly, the checkout system P1 can further improve the age estimation accuracy even when the face image is not more suitable for the age estimation processing.

Further, the checkout system P1 analyzes the face image and determines whether the direction of the face of the customer C1 is front. When the checkout system P1 determines, based on the analysis result of the face image, that the direction of the face of the customer C1 is other than a front direction, the checkout system P1 determines that the installation condition of the checkout system P1 is not satisfied. Accordingly, the checkout system P1 can determine the minor determination condition or the estimated time of the age estimation processing based on the direction of the face of the customer C1 appearing in the face image.

Therefore, even when the age higher than the actual age of the customer C1 is estimated by the age estimation processing using the face image in which the direction of the face of the customer C1 faces a direction other than the front (that is, unsuitable for the age estimation processing) according to an attachment angle or an attachment position (height) of the camera CM, the checkout system P1 can more reliably prevent the purchase of the restricted product due to the minor by the determined minor determination condition. When the checkout system P1 determines that the direction of the face of the customer C1 is not the front and the face image is not suitable for the age estimation processing (that is, the installation condition of the checkout system P1 is not satisfied) based on the analysis result of the face image of the customer C1, the checkout system P1 executes the age estimation processing a plurality of times or over a longer period of time. Accordingly, the checkout system P1 can further improve the age estimation accuracy even when the face image is not more suitable for the age estimation processing.

The checkout system P1 may determine, based on a current date and time, that the installation condition of the checkout system P1 is not satisfied in a time zone or a season (for example, a time zone in one day when an afternoon sun shines into the store, or a time zone in summer when the western day shines into the store) in which strong outdoor light shines into the store. Accordingly, when it is determined that the image quality of the face image captured by the camera CM is in the time zone or the season in which the image quality is assumed to be deteriorated due to surrounding environment (for example, the outdoor light), the checkout system P1 can change the minor determination condition or the estimated time of the age estimation processing. Therefore, it is possible to more reliably prevent the purchase of the restricted product due to the minor.

The checkout system P1 may determine, based on the current date and time, that the installation condition of the checkout system P1 is not satisfied, for example, when the checkout system P1 determines a season or a period in which predetermined pollen is scattered in a large amount, or a season or a period in which seasonal viruses such as cold and influenza are popular (that is, a predetermined season or a period in which the wearing of the mask is increased). The checkout system P1 may determine that the installation condition of the checkout system P1 is not satisfied when information (for example, information indicating that influenza is popular, or information indicating the predetermined season or period in which the predetermined pollen is scattered in a large amount) acquired from another server connected to be able to perform the data communication via a network (not shown) is acquired. Further, the checkout system P1 may determine that the installation condition of the checkout system P1 is not satisfied when it is determined that the wearing of the mask is increased based on the analysis result obtained by analyzing the captured face images of the plurality of customers. Furthermore, in addition to the increase in the wearing of the mask, when it is determined that the wearing of the sunglasses is increased and the wearing of the hat is increased, it may be determined that the installation condition of the checkout system P1 is not satisfied.

Accordingly, when it is assumed that the customer C1 is in the predetermined season or period covering the face with the mask or the like and an image of the entire face of the customer C1 cannot be captured, the checkout system P1 can determine the minor determination condition to be a threshold of a higher estimated age. Therefore, it is possible to more reliably prevent the purchase of the restricted product due to the minor. When the checkout system P1 determines, based on the analysis result of the face image of the customer C1, that the customer C1 is wearing the mask and the face image is not more suitable for the age estimation processing (that is, the installation condition of the checkout system P1 is not satisfied), the checkout system P1 executes the age estimation processing a plurality of times or over a longer period of time. Accordingly, the checkout system P1 can further improve the age estimation accuracy even when the face image is not more suitable for the age estimation processing. Further, when it is assumed that the customer C1 cannot capture the image of the entire face of the customer C1 in a predetermined season or period (for example, a predetermined season or period in which wearing of the sunglasses or the hat increases, such as summer with strong sunlight) in which the customer C1 covers the face with the sunglasses, the hat, or the like, the checkout system P1 can determine a higher estimated age threshold as the minor determination condition, and can more reliably prevent the purchase of the restricted product due to the minor.

Next, the use condition of the store for determining the minor determination condition or the estimated time of the age estimation processing will be described. The use condition of the store is a customer group of the store based on the customer group who uses the store, surrounding information of the store, event information round the store, or the like, and is a condition for determining whether the ratio of minors occupying the customer group is larger than a predetermined ratio (predetermined value). Here, the predetermined value may be set to any value (ratio) by the salesperson, such as 25%, 30%, 40%, or 50%. The checkout system P1 determines that there are many minors when the ratio of minors occupying the customer group is greater than the predetermined ratio (predetermined value), and determines that there are few minors (that is, many adults) when the ratio of minors occupying the customer group is less than the predetermined ratio (predetermined value).

The checkout system P1 requests the salesperson confirmation system CS to transmit age distribution information of the customer who uses the store. The checkout system P1 determines whether the ratio of minors occupying the customer group using the store is equal to or greater than the predetermined value based on the age distribution information of the customer group transmitted from the salesperson confirmation system CS. The checkout system P1 may divide the acquired age distribution information of the customer group into time zones (for example, every hour, daytime, or nighttime), calculate the ratio of minors in each time zone, and determine whether the calculated ratio of minors is equal to or greater than the predetermined value. Accordingly, the checkout system P1 can more adaptively determine (change) the minor determination condition or the estimated time of the age estimation processing based on change in the customer group for each time zone. Therefore, it is possible to more reliably prevent the purchase of the restricted product due to the minor.

The checkout system P1 may determine the use condition of the store based on a position of the store and facility information around the store. The checkout system P1 may determine that the ratio of minors in the customer group of the store is less than the predetermined value when the store is a store located in a place frequently used by the adult, such as a business mall or a downtown, a store located in a place close to a facility used by the adult, such as an integrated resort (IR) facility, a casino, a horse race, or a pachinko restaurant, and is at night. On the other hand, the checkout system P1 may determine that the ratio of minors in the customer group of the store is equal to or greater than the predetermined value when the store is a place close to a facility to be used by the minor, such as a kindergarten, a school, a learning cram, an amusement park, or a sports club, and is in a time zone from early morning to daytime.

Accordingly, the checkout system P1 can more adaptively determine (change) the minor determination condition or the estimated time of the age estimation processing based on the surrounding environment of the store such as the position of the store and the facility information around the store. Therefore, it is possible to more reliably prevent the purchase of the restricted product due to the minor. Even when the age distribution information of the customer group cannot be acquired from the salesperson confirmation system CS, the checkout system P1 can determine the use condition of the store based on the position of the store and the facility information around the store to determine the minor determination condition or the estimated time of the age estimation processing, and can more reliably prevent the purchase of the restricted product due to the minor. In such a case, the checkout system P1 may be connected to another server (for example, a server capable of providing map information, a management server that integrates the checkout system P1 of each store, or a checkout system of another store or a salesperson confirmation system of another store) via a network (not shown) so as to be capable of the data communication, and may acquire information on a position of the store and the facility around the store from another server, or may determine a threshold for executing the age estimation processing of the customer C1 using the face image.

The checkout system P1 may acquire the event information held around the store from another terminal device (for example, the ticket PIA (registered trademark), Loppi (registered trademark), or the like capable of purchasing the product, issuing the coupon, or reserving or paying the ticket) installed in the same store, and may determine that the ratio of minors in the customer group using the store is equal to or greater than the predetermined value based on types of the event information, or a target age of the event. For example, when the checkout system P1 acquires the event information for the minors such as a festival and a hero show for children around the store, the checkout system P1 determines that the ratio of minors in the customer group is equal to or greater than the predetermined value. On the other hand, for example, when the checkout system P1 acquires the event information for the adult such as a live event or a professional baseball game around the store, the checkout system P1 determines that the ratio of minors in the customer group is less than the predetermined value. Further, the checkout system P1 may be limited to the time zone including a time before and after a holding time point of the event based on holding time information of the event, and may determine whether the ratio of minors in the customer group using the store is equal to or greater than the predetermined value.

Accordingly, the checkout system P1 can determine the use condition of the store based on the acquired event information and determine the minor determination condition or the estimated time of the age estimation processing regardless of collection and analysis result of the age distribution information of the customer group. Therefore, it is possible to more reliably prevent the purchase of the restricted product due to the minor.

The checkout system P1 may receive an input operation to the input unit 15 by the salesperson with respect to the use condition of the store. For example, when the salesperson in the store considers that the minors temporarily increase in the customer group (for example, there is a sports meeting in a school near the store, or there is an event for children), the checkout system P1 determines the use condition of the store (that is, whether the ratio of minors is equal to or greater than the predetermined value) based on the input operation by the salesperson.

Accordingly, even if there is information (for example, there is the sports meeting in the school near the store, or there is the event for children) that cannot be acquired from another server connected so as to be able to perform the data communication via the network (not shown), the salesperson can determine the minor determination condition or the estimated time of the age estimation processing in advance. Therefore, it is possible to more reliably prevent the purchase of the restricted product due to the minor.

As described above, the checkout system P1 can more appropriately determine (change) the minor determination condition or the estimated time of the age estimation processing based on an environmental condition of the checkout system P1 and the use condition of the store in which the checkout system P1 is installed.

Since the checkout system P1 determines the minor determination condition based on the environmental condition of the checkout system P1 and the use condition of the store in which the checkout system P1 is installed, even when an age younger than the actual age is estimated in the age estimation processing based on the face image of the customer C1, it is possible to more efficiently prevent the purchase of the restricted product due to the minor. On the other hand, for example, when the store is in the business mall, the checkout system P1 can further reduce the time required for the minor determination processing even in the time zone when the store is crowded by decreasing the threshold of the estimated age indicated by the minor determination condition.

Further, the checkout system P1 determines the estimated time of the age estimation processing based on the environmental condition of the checkout system P1 and the use condition of the store in which the checkout system P1 is installed. Therefore, even when the face image used in the age estimation processing is an image unsuitable for the age estimation processing, the age estimation accuracy can be improved.

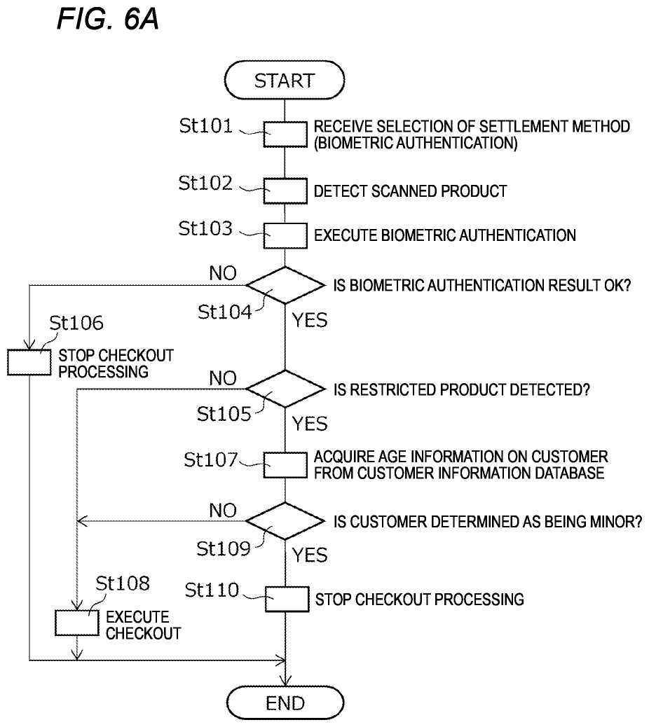

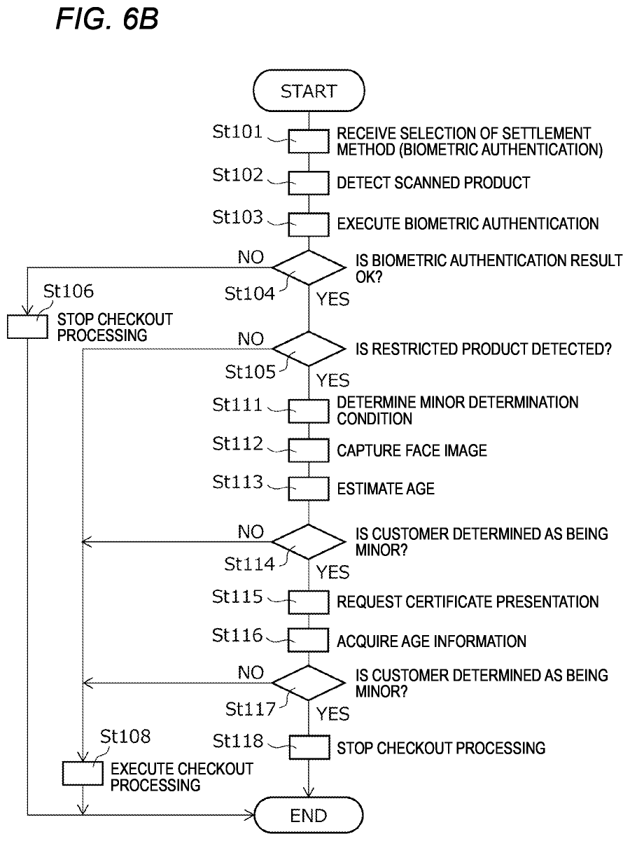

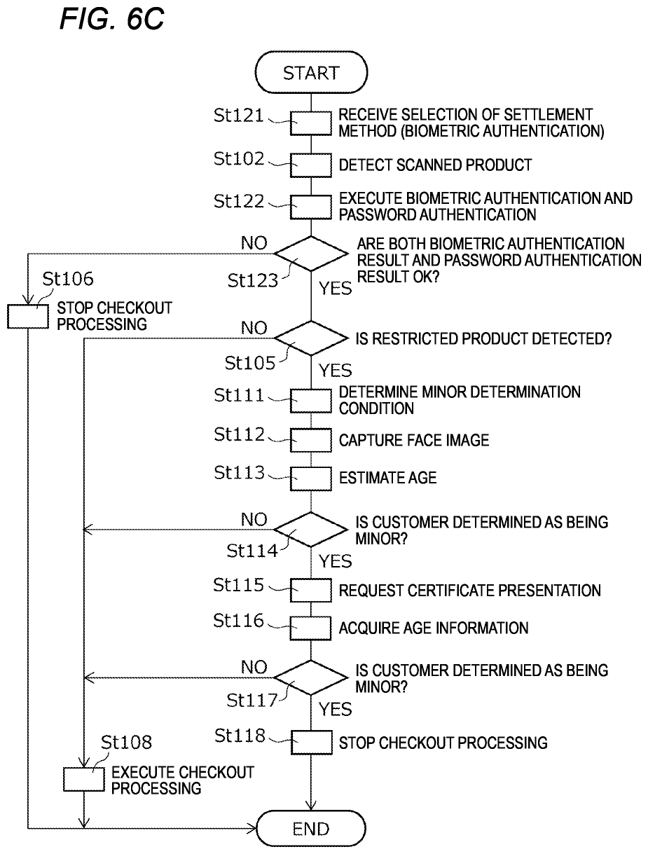

Next, a first operation procedure example of the checkout system P1 according to the first embodiment will be described with reference to FIG. 6A. FIG. 6A is a flowchart showing the first operation procedure example (biometric settlement) of the checkout system P1 according to the first embodiment. The checkout system P1 in the first operation procedure can acquire the age information of the customer C1 from the server S1, and does not execute the age estimation processing.

In the first to third operation procedures shown in FIGS. 6A to 6C, an example of the biometric settlement using the biometric authentication based on the face image of the customer C1 is shown, whereas the biometric settlement is not limited to face authentication. For example, the biometric settlement may be the biometric authentication using a fingerprint, a vein, an iris, or the like.

The first to third operation procedures shown in FIGS. 6A to 6C show an example in which the checkout processing, the purchase permission process, and the minor determination processing are executed by the checkout system P1, respectively. However, the procedures may be executed by the salesperson confirmation system CS, may be executed by the checkout system P1 and the salesperson confirmation system CS, or may be executed by each of the checkout system P1, the salesperson confirmation system CS, and the server S1. Although an example in which the checkout system P1 described in the first to third operation procedures is a self-register is shown, the checkout system P1 may be a register operated by the salesperson in the related art.

The checkout system P1 receives selection of the settlement method based on the operation of the customer C1 on the input unit 15 (St101). In the first operation procedure example shown in FIG. 6A, the customer C1 selects the biometric settlement based on the face authentication. The checkout system P1 determines the purchase permission process including the processing from steps St102 to St110.

The checkout system P1 outputs information (for example, the price information, and the product name) related to the product scanned by the reading unit 13 to the display unit 14 to display the information. The checkout system P1 acquires the product information by referring to the memory 12 based on identification information of the product read by the reading unit 13 (St102).

The checkout system P1 executes the biometric authentication based on the face image of the customer C1 (St103). Specifically, the checkout system P1 captures an image of the customer C1 by the camera CM, associates the captured face image with a control command for requesting the biometric authentication (here, the face authentication) of the customer C1, and transmits the associated face image and control command to the server S1 that provides a biometric settlement service. Based on the control command transmitted from the checkout system P1, the server S1 collates the face image of each of the plurality of customers registered in the customer information database DB with the face image of the customer C1 associated with the control command in the customer information database DB. When it is determined as a result of the collation that the face image similar to or matching the face image of the customer C1 exists in the customer information database DB, the server S1 generates notification information indicating that an authentication result of the face authentication of the customer C1 (that is, a biometric authentication result) is passed, and transmits the notification information to the checkout system P1. On the other hand, when it is determined as the result of the collation that the face image similar to or matching the face image of the customer C1 does not exist in the customer information database DB, the server S1 generates the notification information indicating that the authentication result of the face authentication of the customer C1 (that is, the biometric authentication result) is failed, and transmits the notification information to the checkout system P1. As described above, the checkout system P1 acquires the authentication result transmitted from the server S1.

The checkout system P1 determines whether the biometric authentication result of the customer C1 is passed (that is, “OK”) based on the notification information transmitted from the server S1 (St104). When it is determined in the processing in step St104 that the biometric authentication result of the customer C1 is passed (that is, “OK”) (YES in St104), the checkout system P1 determines whether one or more restricted products of each of one or more products scanned by the reading unit 13 are detected (St105).

On the other hand, when it is determined in the processing in step St104 that the biometric authentication result of the customer C1 is not passed (that is, “OK”) (NO in St104), the checkout system P1 stops the checkout processing (St106). After the processing in step St106, the checkout system P1 may return to the processing in step St101 and proceed to the processing of selecting the settlement method by the customer C1. In such a case, the checkout system P1 may hold each piece of product information of one or more products scanned by the reading unit 13 and omit the processing in step St102.

When it is determined in the processing in step St105 that one or more restricted products of each of one or more products scanned by the reading unit 13 are detected (YES in St105), the checkout system P1 acquires the age information of the customer C1 registered in the customer information database DB in the server S1 (St107). Specifically, the checkout system P1 generates the control command for requesting transmission of the age information on the customer C1 and transmits the control command to the server S1. The server S1 extracts the age information of the customer C1 registered in the customer information database DB based on the control command transmitted from the checkout system P1, and transmits the age information to the checkout system P1. As described above, the checkout system P1 acquires the age information on the customer C1 transmitted from the server S1. In the processing in step St104, when the server S1 transmits the biometric authentication result and the age information on the customer C1 in association with each other to the checkout system P1, the processing in step St107 may be omitted.

On the other hand, when it is determined in the processing in step St105 that one or more restricted products of each of one or more products scanned by the reading unit 13 are not detected (NO in St105), the checkout system P1 executes the checkout processing of one or more products by the settlement method designated by the customer C1 (St108). Specifically, the checkout system P1 transmits one or more pieces of product information (for example, the product name, and the price information of the product) and a settlement request of the product to the server S1 in association with each other. When the checkout system P1 receives a settlement completion notification for the settlement request of the product transmitted from the server S1, the checkout system P1 completes the checkout processing.

The checkout system P1 determines whether the customer C1 is a minor based on the acquired age information on the customer C1 (St109). When it is determined in the processing in step St109 that the customer C1 is the minor (YES in St109), the checkout system P1 stops the checkout processing (St110). On the other hand, when it is determined in the processing in step St109 that the customer C1 is not the minor (NO in St109), the checkout system P1 executes the checkout processing of one or more products by the settlement method designated by the customer C1 (St108).

As described above, the checkout system P1 according to the first embodiment determines the purchase permission process corresponding to the settlement method based on the settlement method designated by the customer Ci (in the example shown in FIG. 6A, the biometric settlement by the face authentication). Accordingly, the checkout system P1 can execute the minor determination processing more suitable for the settlement method, and can execute the checkout processing when it is determined that the customer C1 is not the minor by the minor determination processing.

Next, a second operation procedure example of the checkout system P1 according to the first embodiment will be described with reference to FIG. 6B. FIG. 6B is a flowchart showing the second operation procedure example (biometric settlement) of the checkout system P1 according to the first embodiment. The checkout system P1 in the second operation procedure indicates a case where the age information of the customer Ci cannot be acquired from the server S1, and executes the age estimation processing based on the face image of the customer C1. Since the processing from steps St101 to St106 shown in FIG. 6B are the same as the processing from steps St101 to St106 shown in FIG. 6A, the description thereof will be omitted.

After the processing in step St101, the checkout system P1 determines the purchase permission process including the processing from steps St102 to St106, St108, and St111 to Stl18 shown in FIG. 6B. The checkout system P1 in the second operation procedure example shown in FIG. 6B indicates the purchase permission process determined when the age information of the customer C1 cannot be acquired from the server S1.

When it is not possible to determine in advance whether the age information of the customer C1 can be acquired from the server S1, the checkout system P1 may select one of the purchase permission process shown in FIG. 6A and the purchase permission process shown in FIG. 6C.

In the checkout system P1 in the second operation procedure, in the processing in step St105, when it is determined that one or more restricted products of each of one or more products scanned by the reading unit 13 are detected (YES in St105), the checkout system P1 determines a minor determination condition (that is, a threshold) based on the installation condition of the checkout system P1 and the use condition of the store in which the checkout system P1 is installed (St111). The threshold set in advance by the salesperson may be used as the minor determination condition. In such a case, the checkout system P1 omits the processing in step Stl11.

The checkout system P1 captures an image of the face of the customer C1 one or more times by the camera CM (St112). The checkout system P1 determines, based on an image analysis result of the captured face images of the one or more customers C1 (that is, the installation condition of the checkout system P1) and the use condition of the store in which the checkout system P1 is installed, the estimated time, and executes the age estimation processing of the customer C1 (St113). The checkout system P1 may execute the age estimation processing of the customer C1 based on the face image captured in the processing in step St103. In such a case, the processing in step Stl12 may be omitted. Further, the checkout system P1 may execute the processing in step St113 (the age estimation processing of the customer C1) in step St103. In such a case, the processing from steps Stll2 to Stll3 may be omitted.

The checkout system P1 determines whether the customer C1 is the minor based on the estimated age information of the customer C1 and the determined minor determination condition (St114).

When it is determined in the processing in step St114 that the customer C1 is the minor (that is, the estimated age information of the customer C1 is not equal to or greater than the threshold) (YES in St114), the checkout system P1 generates a screen for requesting the customer C1 to present a certificate including the age information, information on the date of birth, or the like of the customer C1 (for example, the driver license, the individual number card, the health insurance card, etc.), and outputs the screen to the display unit 14 to display the screen (St115). A certificate presentation request may be performed by voice output from a speaker (not shown).

On the other hand, when it is determined in the processing in step St114 that the customer C1 is not the minor (that is, the estimated age information of the customer C1 is equal to or greater than the threshold) (NO in St114), the checkout system P1 executes the checkout processing of one or more products by the settlement method designated by the customer C1 (Stl08). Specifically, the checkout system P1 transmits one or more pieces of product information (for example, the product name, and the price information of the product) and a settlement request of the product to the server S1 in association with each other. When the checkout system P1 receives the settlement completion notification for the settlement request of the product transmitted from the server S1, the checkout system P1 completes the checkout processing.

The checkout system P1 captures an image of the certificate presented by the customer C1 with the camera CM. The checkout system P1 executes the optical character recognition processing (OCR) on the captured image to acquire the age information of the customer C1 (St116). Confirmation of the age of the customer C1 based on the certificate may be performed by the salesperson. For example, in the processing in step St115, the checkout system P1 generates a screen for requesting presentation of the certificate including a button for requesting visual confirmation by the salesperson such as “call a salesperson”. When the checkout system P1 receives a selection (pressing) operation of the button by the customer C1, the checkout system P1 may call the salesperson and request the visual confirmation of the age of the customer C1 described in the certificate (that is, confirmation that the customer C1 is not the minor).

The checkout system P1 determines whether the customer C1 is the minor based on the acquired age information of the customer C1 and the determined minor determination condition (determination condition) (St117). When the visual confirmation by the salesperson is performed, the checkout system P1 determines whether the customer C1 is the minor based on the input operation by the salesperson.

When it is determined in the processing in step St117 that the customer C1 is the minor (YES in St117), the checkout system P1 stops the checkout processing (St118).

On the other hand, when it is determined in the processing in step St117 that the customer C1 is not the minor (NO in St117), the checkout system P1 executes the checkout processing of one or more products by the settlement method designated by the customer C1 (Stl08).

The face image of the customer C1 used in the age estimation processing in step Stl13 in the second operation procedure shown in FIG. 6B may be the face image of the customer C1 captured by the processing in step St103. Accordingly, the checkout system P1 can omit the processing in step Stl12 and more efficiently execute the purchase permission process.

When the face image of the customer C1 is printed on the certificate in the processing in step Stl16 in the second operation procedure shown in FIG. 6B, the checkout system P1 may execute face authentication processing in step St104 again using the face image of the customer C1 appearing on the certificate and the face image of the customer C1 used in the age estimation processing in step Stl13. Accordingly, the checkout system P1 can improve identity verification accuracy of the customer C1 and more effectively prevent a spoofing action by another person.

As described above, the checkout system P1 according to the first embodiment determines the purchase permission process corresponding to the settlement method based on the settlement method designated by the customer C1 (in the example shown in FIG. 6B, the biometric settlement by the face authentication). Even when the age information of the customer Ci cannot be acquired from the server S1, the checkout system P1 can more accurately determine whether the restricted product of the customer C1 can be purchased by performing the age estimation processing more suitable for the settlement method or acquiring the age information based on the certificate.

Next, a third operation procedure example of the checkout system P1 according to the first embodiment will be described with reference to FIG. 6C. FIG. 6C is a flowchart showing the third operation procedure example (biometric settlement) of the checkout system P1 according to the first embodiment. The checkout system P1 in the third operation procedure indicates a case where the age information of the customer Ci cannot be acquired from the server S1 and password authentication is executed, and executes the age estimation processing based on the face image of the customer Ci. Since the processing in steps St102, St105 and St106, and St111 to St118 shown in FIG. 6C are the same as the processing shown in FIGS. 6A and 6B, the description thereof will be omitted.

The checkout system P1 receives selection of the settlement method based on the operation of the customer C1 on the input unit 15 (St121). In the first operation procedure example shown in FIG. 6C, the customer C1 selects the biometric settlement based on the face authentication and the password authentication.

The checkout system P1 determines the purchase permission process including the processing in steps St102, St106, St108, Stll to St118, and St121 to St123 based on the designated settlement method (here, the biometric settlement by the face authentication and the password authentication).

When it is not possible to determine in advance whether the age information of the customer C1 can be acquired from the server S1, the checkout system P1 may select one of the purchase permission process shown in FIG. 6A and the purchase permission process shown in FIG. 6B.

The checkout system P1 outputs information (for example, the price information, and the product name) related to the product scanned by the reading unit 13 to the display unit 14 to display the information. The checkout system P1 acquires the product information by referring to the memory 12 based on identification information of the product read by the reading unit 13 (St102).

The checkout system P1 executes the biometric authentication and the password authentication based on the face image of the customer C1 (St122). Specifically, the checkout system P1 generates a screen for requesting the input operation of the password to the input unit 15 to the customer C1, and outputs the screen to the display unit 14 to display the screen. The input operation of the password may be performed by the voice output from the speaker (not shown). The checkout system P1 transmits the password input by the customer C1, the face image of the customer C1 captured by the camera CM, and the control command for requesting the biometric authentication (here, the face authentication) and the password authentication of the customer C1 to the server S1 that provides the biometric settlement service in association with each other.

Based on the control command transmitted from the checkout system P1, the server S1 collates the password of each of the plurality of customers registered in the customer information database DB with the password of the customer C1 associated with the control command in the customer information database DB. When it is determined as the result of the collation that the password of the customer C1 registered in the customer information database DB matches the input password transmitted from the checkout system P1, the server S1 determines that the authentication result of the password authentication of the customer C1 is passed.

The server S1 collates the face image of each of the plurality of customers registered in the customer information database DB with the face image of the customer C1 associated with the control command in the customer information database DB. When it is determined as the result of the collation that the face image similar to or matching the face image of the customer C1 exists in the customer information database DB, the server S1 determines that the authentication result of the face authentication of the customer C1 (that is, the biometric authentication result) is passed.

When it is determined that both the authentication result of the password authentication and the authentication result of the biometric authentication are passed, the server S1 generates the notification information indicating that the authentication result of the password authentication and the biometric authentication is passed, and transmits the notification information to the checkout system P1. On the other hand, when it is determined that both the authentication result of the password authentication and the authentication result of the biometric authentication are not passed, the server S1 generates the notification information indicating that the authentication result of the password authentication and the biometric authentication is failed, and transmits the notification information to the checkout system P1. The checkout system P1 acquires the authentication result transmitted from the server S1.

The checkout system P1 determines whether the biometric authentication result and the password authentication result of the customer C1 are passed (that is, “OK”) based on the notification information transmitted from the server S1 (St123). When it is determined in the processing in step St123 that the biometric authentication result of the customer C1 is passed (that is, “OK”) (YES in St123), the checkout system P1 determines whether one or more restricted products of each of one or more products scanned by the reading unit 13 are detected (St105).

On the other hand, when it is determined in the processing in step St123 that the biometric authentication result of the customer C1 is not passed (that is, “OK”) (NO in St123), the checkout system P1 stops the checkout processing (St106). After the processing in step St106, the checkout system P1 may return to the processing in step St101, and may proceed to the processing of selecting the settlement method by the customer C1 or a password input operation by the customer C1 in step St122. In such a case, the checkout system P1 may hold each piece of product information of one or more products scanned by the reading unit 13 and omit the processing in step St102.

As described above, the checkout system P1 according to the first embodiment determines the purchase permission process corresponding to the settlement method based on the settlement method (in the example shown in FIG. 6C, the biometric authentication and the password authentication by the face authentication) designated by the customer C1. Accordingly, the checkout system P1 can execute the minor determination processing more suitable for the settlement method, and can execute the checkout processing of each of the one or more products only when it is determined that the customer C1 is not the minor by the minor determination processing.

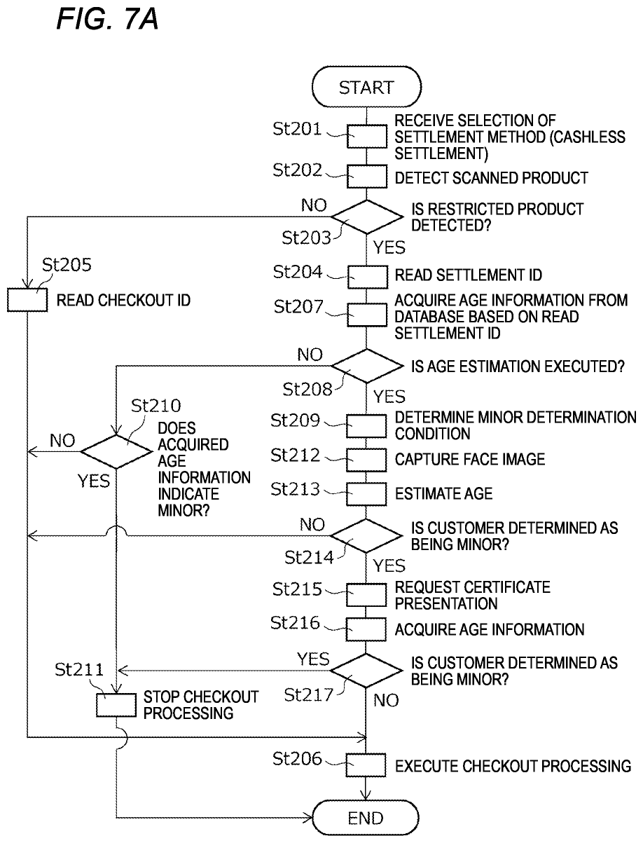

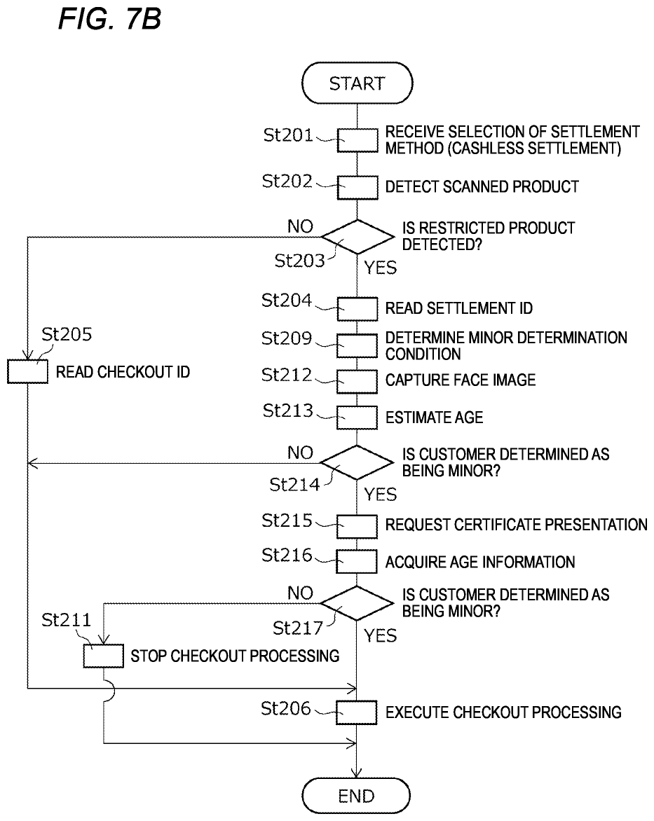

Next, a fourth operation procedure example of the checkout system P1 according to the first embodiment will be described with reference to FIG. 7A. FIG. 7A is a flowchart showing the fourth operation procedure example (cashless settlement) of the checkout system P1 according to the first embodiment. The checkout system P1 in the fourth operation procedure can acquire the age information of the customer C1 from the server S1, and selectively executes the age estimation processing.

The fourth and fifth operation procedures shown in FIGS. 7A and 7B show an example in which the checkout processing, the purchase permission process, and the minor determination processing are executed by the checkout system P1, respectively. However, the procedures may be executed by the salesperson confirmation system CS, may be executed by the checkout system P1 and the salesperson confirmation system CS, or may be executed by each of the checkout system P1, the salesperson confirmation system CS, and the server S1. Although an example in which the checkout system P1 described in the fourth and fifth operation procedures is a self-register is shown, the checkout system P1 may be a register operated by the salesperson in the related art.

The checkout system P1 receives selection of the settlement method based on the operation of the customer C1 on the input unit 15 (St201). In the fourth operation procedure example shown in FIG. 7A, the customer C1 selects the cashless settlement using any settlement medium. The checkout system P1 determines the purchase permission process including the processing in steps St202 to St217 based on the designated settlement method (here, the cashless settlement).

The checkout system P1 outputs information (for example, the price information, and the product name) related to the product scanned by the reading unit 13 to the display unit 14 to display the information. The checkout system P1 acquires the product information by referring to the memory 12 based on the identification information of the product read by the reading unit 13 (St202).

The checkout system P1 determines whether one or more restricted products of each of one or more products scanned by the reading unit 13 are detected (St203).

In the processing in step St203, when it is determined that one or more restricted products of each of one or more products scanned by the reading unit 13 are detected (YES in St203), the checkout system P1 generates a screen for requesting the customer C1 to present the settlement medium (for example, the credit card, the debit card, or the screen of the smartphone), and outputs the screen to the display unit 14 to display the screen. The checkout system P1 reads the ID of the settlement medium presented by the reading unit 13 (St204).

On the other hand, in the processing in step St203, when it is determined that one or more restricted products of each of one or more products scanned by the reading unit 13 are not detected (NO in St203), the checkout system P1 generates a screen for requesting the customer C1 to present the settlement medium (for example, the credit card, the debit card, or the screen of the smartphone), and outputs the screen to the display unit 14 to display the screen. The checkout system P1 reads the ID of the settlement medium presented by the reading unit 13 (St205), and executes the checkout processing based on the read ID of the settlement medium (St206). Specifically, the checkout system P1 transmits the ID of the settlement medium, the one or more pieces of product information (for example, the product name, and the price information of the product) and the settlement request of the product to the server S1 in association with each other. When the checkout system P1 receives the settlement completion notification for the settlement request of the product transmitted from the server S1, the checkout system P1 completes the checkout processing.

The checkout system P1 acquires the age information of the customer C1 registered in the customer information database DB in the server S1 (St207). Specifically, the checkout system P1 associates the ID of the read settlement medium with a control command for requesting the age information of the customer C1 indicated by the ID, and transmits the ID and the control command to the server S1 that provides a cashless settlement service using the settlement medium. Based on the control command transmitted from the checkout system P1, the server S1 refers to the customer information database DB, extracts the age information of the customer C1 associated with the same ID as the ID of the settlement medium transmitted from the checkout system P1, and transmits the age information to the checkout system P1. Accordingly, the checkout system P1 acquires the age information of the customer C1 transmitted from the server S1.

The checkout system P1 determines whether to execute the age estimation processing (St208). The checkout system P1 may determine whether to execute the age estimation processing based on the use condition of the store in which the checkout system P1 is installed. For example, the checkout system P1 may determine that the age estimation processing is to be executed when it is determined that the ratio of minors in the customer group of the store is equal to or greater than the predetermined value as the use condition of the store, or may determine that the age estimation processing is to be executed in a case of a time zone when the ratio of minors in the customer group is equal to or greater than the predetermined value. When execution of the age estimation processing is set in advance by the salesperson, the checkout system P1 may determine that the age estimation processing is to be executed, or may determine that the age estimation processing is to be executed according to the type of the settlement medium. For example, the checkout system P1 may determine to execute the age estimation processing when the settlement medium is the smartphone or the credit card, or may determine to execute the age estimation processing when a management company of the settlement medium or a company which is a provider of an application of the settlement medium recommends the execution of the age estimation processing in advance. Further, the above-described method of determining whether to execute the age estimation processing is an example, and the present disclosure is not limited thereto.

When it is determined in the processing in step St208 that the age estimation processing is to be executed (YES in St208), the checkout system P1 determines the minor determination condition (threshold) based on the installation condition of the checkout system P1 and the use condition of the store in which the checkout system P1 is installed (St209). Further, the threshold set in advance by the salesperson may be used as the minor determination condition. In such a case, the checkout system P1 may omit the processing in step St209.

On the other hand, when it is determined in the processing in step St208 that the age estimation processing is not executed (NO in St208), the checkout system P1 determines whether the age information of the customer C1 acquired from the server S1 indicates the minor (St210). When it is determined in the processing in step St210 that the customer C1 is the minor (YES in St210), the checkout system P1 stops the checkout processing (St211). On the other hand, when it is determined in the processing in step St210 that the customer C1 is not the minor (NO in St210), the checkout system P1 executes the checkout processing of one or more products by the settlement method designated by the customer C1 (St206).

The checkout system P1 captures an image of the face of the customer C1 one or more times by the camera CM (St212). The checkout system P1 determines, based on an image analysis result of the captured face images of the one or more customers C1 (that is, the installation condition of the checkout system P1) and the use condition of the store in which the checkout system P1 is installed, the estimated time, and executes the age estimation processing of the customer C1 (St213).

The checkout system P1 determines whether the customer C1 is the minor based on the estimated age information of the customer C1 and the determined minor determination condition (St214).

When it is determined in the processing in step St214 that the customer C1 is the minor (that is, the estimated age information of the customer C1 is not equal to or greater than the threshold) (YES in St214), the checkout system P1 generates a screen for requesting the customer C1 to present the certificate including the age information, information on the date of birth, or the like of the customer C1 (for example, the driver license, the individual number card, the health insurance card, etc.), and outputs the screen to the display unit 14 to display the screen (St215). The certificate presentation request may be performed by the voice output from the speaker (not shown).

On the other hand, when it is determined in the processing in step St214 that the customer C1 is not the minor (that is, the estimated age information of the customer C1 is equal to or greater than the threshold) (NO in St214), the checkout system P1 executes the checkout processing of one or more products by the settlement method designated by the customer C1 (St211).

The checkout system P1 captures an image of the certificate presented by the customer C1 with the camera CM. The checkout system P1 executes the optical character recognition processing (OCR) on the captured image to acquire the age information of the customer C1 (St216). The confirmation of the age of the customer C1 based on the certificate may be performed by the salesperson. For example, in the processing in step St215, the checkout system P1 generates a screen for requesting presentation of the certificate including a button for requesting visual confirmation by the salesperson such as “call a salesperson”. When the checkout system P1 receives a selection (pressing) operation of the button by the customer C1, the checkout system P1 may call the salesperson and request the visual confirmation of the age of the customer C1 described in the certificate (that is, confirmation that the customer C1 is not the minor).

The checkout system P1 determines whether the customer C1 is the minor based on the acquired age information of the customer C1 and the determined minor determination condition (threshold) (St217). When the visual confirmation by the salesperson is performed, the checkout system P1 determines whether the customer C1 is the minor based on the input operation by the salesperson.

When it is determined in the processing in step St217 that the customer C1 is the minor (YES in St217), the checkout system P1 stops the checkout processing (St211).

On the other hand, when it is determined in the processing in step St217 that the customer C1 is not the minor (NO in St217), the checkout system P1 executes the checkout processing of one or more products by the settlement method designated by the customer C1 (St206).

Age information acquisition processing and the minor determination processing based on the certificate executed in steps St215 to St217 in the fourth operation procedure shown in FIG. 7A may be executed only when an age difference between the age information of the customer C1 acquired from the server S1 in step St207 and the estimated age information of the customer C1 estimated in step St213 is a predetermined value (for example, 5 years old or more, or 10 years old or more).

In such a case, after the processing in step St214, the checkout system P1 may perform processing of determining whether the age difference between the age information of the customer C1 acquired from the server S1 and the estimated age information of the customer C1 is the predetermined value (for example, 5 years old or more, or 10 years old or more). Further, when the face image of the customer C1 is present on the certificate, the checkout system P1 may compare the face image of the certificate with the face image captured in step St212 by image processing to perform identity verification. When it is determined that the age difference from the estimated age information of the customer C1 is not the predetermined value (for example, 5 years old or more, or 10 years old or more), the checkout system P1 may proceed to the processing in step St215. When it is determined that the age difference from the estimated age information of the customer C1 is the predetermined value (for example, 5 years old or more, or 10 years old or more), the checkout system P1 may proceed to the processing in step St211, or may generate an alert indicating that there is a suspicion of the spoofing action by another person and transmit the alert to the salesperson confirmation system CS or another manned register. Accordingly, the checkout system P1 can stop the checkout of the product when there is an unauthorized use of the settlement medium, the spoofing action, or the like by another person. The checkout system P1 can notify the salesperson that there is the suspicion of the spoofing action by another person.

The age information acquisition processing and the minor determination processing based on the certificate executed in steps St215 to St217 in the fourth operation procedure shown in FIG. 7A may be executed when the age information of the customer C1 acquired from the server S1 in the processing in step St207 indicates the adult and the estimated age information of the customer C1 estimated in the processing in step St213 indicates the minor. Accordingly, even if the estimated age information of the customer C1 is incorrect, the checkout system P1 can acquire the age information of the customer C1 by the certificate including the age information of the customer C1, and thus can execute the checkout processing.

Further, the age information acquisition process and the minor determination processing based on the certificate executed in steps St215 to St217 in the fourth operation procedure shown in FIG. 7A may be executed when the age information of the customer C1 acquired from the server S1 in the processing in step St207 indicates the adult and the estimated age information of the customer C1 is determined to be the minor in the processing in step St214. Accordingly, even when the estimated age information of the customer C1 is erroneously determined to be the minor when a stricter minor determination condition (that is, a higher threshold) is determined, the checkout system P1 can execute the checkout processing of each of one or more products based on the age information of the customer C1 acquired based on the certificate including the age information of the customer C1.

As described above, the checkout system P1 according to the first embodiment determines the purchase permission process corresponding to the settlement method based on the settlement method designated by the customer C1 (the cashless settlement in the example shown in FIG. 7A). Accordingly, the checkout system P1 can execute the minor determination processing more suitable for the settlement method, and can execute the checkout processing when it is determined that the customer C1 is not the minor by the minor determination processing.

Next, a fifth operation procedure example of the checkout system P1 according to the first embodiment will be described with reference to FIG. 7B. FIG. 7B is a flowchart showing the fifth operation procedure example (cashless settlement) of the checkout system P1 according to the first embodiment. The checkout system P1 in the fifth operation procedure cannot acquire the age information of the customer C1 from the server S1, and executes the age estimation processing.

Since the fifth operation procedure shown in FIG. 7B is an operation procedure in which the processing shown in steps St207 and St208 and step St210 in the fourth operation procedure shown in FIG. 7A are omitted, only steps St203 to St209 will be described.

In the example shown in FIG. 7B, the checkout system P1 determines the purchase permission process including each processing in steps St202 to St206, St209, and St211 to St217 based on the designated settlement method (here, the cashless settlement).

In the processing in step St203, when it is determined that one or more restricted products of each of one or more products scanned by the reading unit 13 are detected (YES in St203), the checkout system P1 generates a screen for requesting the customer C1 to present the settlement medium (for example, the credit card, the debit card, or the screen of the smartphone), and outputs the screen to the display unit 14 to display the screen. The checkout system P1 reads the ID of the settlement medium presented by the reading unit 13 (St204). After the processing in step St204, the checkout system P1 determines the minor determination condition (threshold) to be used in the minor determination processing (St209).

On the other hand, in the processing in step St203, when it is determined that one or more restricted products of each of one or more products scanned by the reading unit 13 are not detected (NO in St203), the checkout system P1 generates a screen for requesting the customer C1 to present the settlement medium (for example, the credit card, the debit card, or the screen of the smartphone), and outputs the screen to the display unit 14 to display the screen. The checkout system P1 reads the ID of the settlement medium presented by the reading unit 13 (St205), and executes the checkout processing based on the read ID of the settlement medium (St206). Specifically, the checkout system P1 transmits the ID of the settlement medium, the one or more pieces of product information (for example, the product name, and the price information of the product) and the settlement request of the product to the server S1 in association with each other. When the checkout system P1 receives the settlement completion notification for the settlement request of the product transmitted from the server S1, the checkout system P1 completes the checkout processing.

As described above, the checkout system P1 according to the first embodiment determines the purchase permission process corresponding to the settlement method based on the settlement method designated by the customer C1. Accordingly, the checkout system P1 can execute the minor determination processing more suitable for the settlement method, and can execute the checkout processing when it is determined that the customer C1 is not the minor by the minor determination processing.

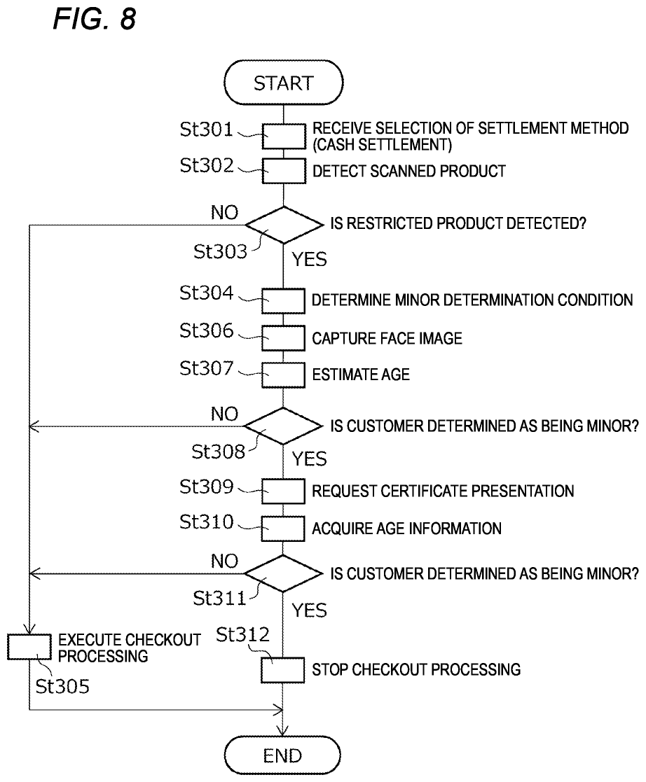

Next, a sixth operation procedure example of the checkout system P1 according to the first embodiment will be described with reference to FIG. 8. FIG. 8 is a flowchart showing the sixth operation procedure example (cash settlement) of the checkout system according to the first embodiment. The checkout system P1 in the sixth operation procedure executes the age estimation processing.

The sixth operation procedure shown in FIG. 8 shows an example in which the checkout processing, the purchase permission process, and the minor determination processing are executed by the checkout system P1, respectively. However, the procedures may be executed by the salesperson confirmation system CS, may be executed by the checkout system P1 and the salesperson confirmation system CS, or may be executed by each of the checkout system P1, the salesperson confirmation system CS, and the server S1. Although the example in which the checkout system P1 described in the sixth operation procedure is a self-register is shown, the checkout system P1 may be a register operated by the salesperson in the related art.

The checkout system P1 receives selection of the settlement method based on the operation of the customer C1 on the input unit 15 (St301). In the sixth operation procedure example shown in FIG. 8, the customer C1 selects the cash settlement. The checkout system P1 determines the purchase permission process including the processing in steps St302 to St312 based on the designated settlement method (here, the cash settlement).

The checkout system P1 outputs information (for example, the price information, and the product name) related to the product scanned by the reading unit 13 to the display unit 14 to display the information. The checkout system P1 acquires the product information by referring to the memory 12 based on the identification information of the product read by the reading unit 13 (St302).

The checkout system P1 determines whether one or more restricted products of each of one or more products scanned by the reading unit 13 are detected (St303).

When it is determined in the processing in step St303 that one or more restricted products of each of one or more products scanned by the reading unit 13 are detected (YES in St303), the checkout system P1 determines the minor determination condition (threshold) based on the installation condition of the checkout system P1 and the use condition of the store in which the checkout system P1 is installed (St304). Further, the threshold set in advance by the salesperson may be used as the minor determination condition. In such a case, the checkout system P1 may omit the processing in step St304.

On the other hand, when it is determined in the processing in step St303 that one or more restricted products of each of the one or more products scanned by the reading unit 13 are not detected (NO in St303), the checkout system P1 executes the checkout processing by cash (St305). Specifically, the checkout system P1 displays, on the display unit 14, a screen for requesting the customer C1 to deposit a total price of all the products to be checked out. The checkout system P1 counts a total amount of cash deposited in the checkout unit 16. When it is determined that the total amount of all the products to be checked out is deposited, the checkout system P1 stores all the product information purchased by the customer C1 and deposit information in association with each other, and completes the checkout processing. The checkout system P1 may transmit all the product information purchased by the customer C1, the deposit information, and the estimated age information of the customer C1 or the age information of the customer C1 read from the certificate to the salesperson confirmation system CS in association with each other.

The checkout system P1 captures an image of the face of the customer C1 one or more times by the camera CM (St306). The checkout system P1 determines, based on an image analysis result of the captured face images of the one or more customers C1 (that is, the installation condition of the checkout system P1) and the use condition of the store in which the checkout system P1 is installed, the estimated time, and executes the age estimation processing of the customer C1 (St307).

The checkout system P1 determines whether the customer C1 is the minor based on the estimated age information of the customer C1 and the determined minor determination condition (St308).

When it is determined in the processing in step St308 that the customer C1 is the minor (that is, the estimated age information of the customer C1 is not equal to or greater than the threshold) (YES in St308), the checkout system P1 generates a screen for requesting the customer C1 to present the certificate including the age information, information on the date of birth, or the like of the customer C1 (for example, the driver license, the individual number card, the health insurance card, etc.), and outputs the screen to the display unit 14 to display the screen (St309). The certificate presentation request may be performed by the voice output from the speaker (not shown).

On the other hand, when it is determined in the processing in step St308 that the customer C1 is not the minor (that is, the estimated age information of the customer C1 is equal to or greater than the threshold) (NO in St308), the checkout system P1 executes the checkout processing of one or more products by cash (St305).

The checkout system P1 captures an image of the certificate presented by the customer C1 with the camera CM. The checkout system P1 executes the optical character recognition processing (OCR) on the captured image to acquire the age information of the customer C1 (St310). The confirmation of the age of the customer C1 based on the certificate may be performed by the salesperson. For example, in the processing in step St309, the checkout system P1 generates a screen for requesting presentation of the certificate including a button for requesting visual confirmation by the salesperson such as “call a salesperson”. When the checkout system P1 receives a selection (pressing) operation of the button by the customer C1, the checkout system P1 may call the salesperson and request the visual confirmation of the age of the customer C1 described in the certificate (that is, confirmation that the customer C1 is not the minor).

The checkout system P1 determines whether the customer C1 is the minor based on the acquired age information of the customer C1 and the determined minor determination condition (determination condition) (St311). When the visual confirmation by the salesperson is performed, the checkout system P1 determines whether the customer C1 is the minor based on the input operation by the salesperson.

When it is determined in the processing in step St311 that the customer C1 is the minor (YES in St311), the checkout system P1 stops the checkout processing (St312).

On the other hand, when it is determined in the processing in step St311 that the customer C1 is not the minor (NO in St311), the checkout system P1 executes the checkout processing of one or more products by the settlement method designated by the customer C1 (St305).

As described above, the checkout system P1 according to the first embodiment determines the purchase permission process corresponding to the settlement method based on the settlement method designated by the customer C1 (the cash settlement in the example shown in FIG. 8). Accordingly, the checkout system P1 can execute the minor determination processing more suitable for the settlement method, and can execute the checkout processing for each of the one or more products when it is determined that the customer C1 is not the minor by the minor determination processing.

As described above, the checkout system P1 according to the first embodiment is implemented by one or more computers, and includes the product detection unit 11A that detects the product to be purchased, the determination unit 11B that detects whether the restricted product is included in the detected one or more products, the input unit 15 capable of receiving a designation operation of the settlement method by the customer, the reading unit 13 capable of reading settlement information necessary for checkout from the settlement medium (for example, the credit card, the debit card, the screen of the smartphone, the hand, the finger, or eyes of the customer C1) corresponding to the settlement method, the communication unit 10 or the camera CM (an example of the acquisition unit) that acquires the age information of the customer C1 corresponding to the settlement method, and the processor 11 that determines the purchase permission process of the restricted product based on whether the age information can be acquired by the communication unit 10 corresponding to the settlement method when the restricted product is detected by the determination unit 11B.

Accordingly, the checkout system P1 according to the first embodiment can support the customer C1 or the salesperson to efficiently perform the checkout processing of the restricted product by determining a purchase process customer of the adaptive restricted product by the settlement method designated by the customer C1.

As described above, when the age information can be acquired, the processor 11 in the checkout system P1 according to the first embodiment determines the purchase permission process including a step of acquiring the age information of the customer C1 (for example, step St107 shown in FIG. 6A or step St207 shown in FIG. 7A) and a step of determining whether the customer can purchase the restricted product based on the acquired age information (for example, step St109 shown in FIG. 6A or step St210 shown in FIG. 7A). Accordingly, when it is possible to acquire the age information of the customer C1 associated with the biometric authentication (for example, face authentication, fingerprint authentication, or iris authentication) or a checkout ID from the server S1 capable of providing a settlement service, the checkout system P1 according to the first embodiment can determine the purchase permission process in which the age estimation process based on the face image is omitted. Therefore, when the age estimation processing is not necessary, the checkout system P1 can reduce the time required for the age estimation processing and the minor determination processing from the capturing of the face image of the customer C1, and thus can reduce the time required for the checkout processing per customer. Since the checkout system P1 can automatically determine the purchase permission process based on the settlement method designated by the customer C1, it is possible to more efficiently support the checkout processing performed by the customer C1 and the salesperson.

As described above, when the age information cannot be acquired, the processor 11 in the checkout system P1 according to the first embodiment determines the purchase permission process including a step of estimating the age of the customer based on the face image of the customer C1 (for example, step St113 shown in FIG. 6B and FIG. 6C, step St213 shown in FIG. 7A to FIG. 7B, or step St307 shown in FIG. 8) and a step of determining whether the customer can purchase the restricted product based on the estimated age of the customer C1 (for example, step St114 shown in FIG. 6B and FIG. 6C, step St214 shown in FIG. 7A to FIG. 7B, or step St308 shown in FIG. 8). Accordingly, when the age estimation processing is necessary, the checkout system P1 according to the first embodiment can automatically determine the purchase permission process including the age estimation processing and the minor determination processing from the capturing of the face image of the customer C1 based on the settlement method designated by the customer C1, and thus can more efficiently support the checkout processing performed by the customer C1 and the salesperson.

As described above, when it is determined that the customer cannot purchase the restricted product based on the estimated age of the customer, the processor 11 in the checkout system P1 according to the first embodiment determines the purchase permission process including a step of requesting the presentation of the certificate in which the age information of the customer is described (for example, step St115 shown in FIGS. 6B and 6C, step St215 shown in FIGS. 7A and 7B, or step St309 shown in FIG. 8), a step of executing reading of the age information from the presented certificate (for example, step St116 shown in FIGS. 6B and 6C, step St216 shown in FIGS. 7A and 7B, or step St310 shown in FIG. 8), and a step of determining whether the restricted product can be purchased based on the read age information (for example, step St117 shown in FIGS. 6B and 6C, step St217 shown in FIGS. 7A and 7B, or step St311 shown in FIG. 8). Accordingly, the checkout system P1 according to the first embodiment can automatically determine the purchase permission process including the age estimation processing and the minor determination processing from the capturing of the face image of the customer C1 based on the settlement method designated by the customer C1. Even when it is determined that the customer C1 is the minor by the minor determination processing based on the estimated age information of the customer C1, the checkout system P1 can execute the minor determination process of the customer C1 by reading the age information or the information on the date of birth of the customer C1 described in the certificate (for example, the driver license, the individual number card, the health insurance card, etc.), and thus can more efficiently support the checkout processing performed by the customer C1 and the salesperson.

As described above, when it is determined that the age difference between the age information associated with the settlement medium (for example, the credit card, the debit card, the ID of the smartphone, or the biometric information used for biometric authentication) and the estimated age of the customer is equal to or greater than the predetermined value, the processor 11 in the checkout system P1 according to the first embodiment determines the purchase permission process including a step of requesting the presentation of the certificate in which the age information of the customer is described (for example, step St115 shown in FIGS. 6B and 6C, step St215 shown in FIGS. 7A and 7B, or step St309 shown in FIG. 8), a step of executing reading of the age information from the presented certificate (for example, step St116 shown in FIGS. 6B and 6C, step St216 shown in FIGS. 7A and 7B, or step St3O10 shown in FIG. 8), and a step of determining whether the restricted product can be purchased based on the read age information (for example, step St117 shown in FIGS. 6B and 6C, step St217 shown in FIGS. 7A and 7B, or step St311 shown in FIG. 8). Accordingly, when the age difference between the age information associated with the settlement medium and the estimated age of the customer is equal to or greater than the predetermined value, the checkout system P1 according to the first embodiment can more effectively prevent the unauthorized use of the settlement medium by another person, the spoofing action, or the like by executing the minor determination processing using the certificate.

As described above, when the processor 11 in the checkout system P1 according to the first embodiment determines that the age difference between the age information associated with the settlement medium (for example, the credit card, the debit card, the ID of the smartphone, or the biometric information used for the biometric authentication) and the estimated age of the customer C1 is equal to or greater than the predetermined value, the processor 11 outputs the alert for indicating the unauthorized use of the settlement medium. Accordingly, the checkout system P1 according to the first embodiment can more effectively prevent the unauthorized use of the settlement medium by another person, the spoofing action, or the like, and can request the salesperson to perform the identity verification or the like using the certificate (for example, the driver license, the individual number card, the health insurance card, etc.).

As described above, the processor 11 in the checkout system P1 according to the first embodiment determines whether the age information can be acquired when the designated settlement method is the biometric settlement. Accordingly, the checkout system P1 according to the first embodiment can determine whether the age estimation processing based on the face image is necessary based on whether there is the age information associated with the biometric information used for the biometric authentication in the biometric authentication in which possibility of the spoofing action is lower as the settlement medium.

As described above, when the designated settlement method is the cashless settlement, the processor 11 in the checkout system P1 according to the first embodiment determines that the age information cannot be acquired. Accordingly, the checkout system P1 according to the first embodiment can determine that the age estimation processing based on the face image is necessary in the cashless settlement in which the unauthorized use, the spoofing action, or the like is more likely to be performed. Even when a minor child tries to purchase the restricted product using the settlement medium of a parent, the checkout system P1 can efficiently prevent the minor child from purchasing the restricted product by the age estimation processing based on the face image.

As described above, when the designated settlement method is the cash settlement, the processor 11 in the checkout system P1 according to the first embodiment determines that the age information cannot be acquired. Accordingly, the checkout system P1 according to the first embodiment can determine whether the customer C1 can purchase the restricted product by the age estimation processing based on the face image.

As described above, the checkout system P1 according to the first embodiment is implemented by one or more computers, and includes the product detection unit 11A that detects the product to be purchased, the product detection unit 11A (an example of the detection unit) that detects whether the restricted product is included in the detected product, the camera CM that captures the face image of the customer C1 when the restricted product is detected by the determination unit 11B, the determination unit 11B (an example of an age estimation unit) that performs the age estimation processing of the customer C1 based on the face image captured by the camera CM, and the determination unit 11B that determines whether the customer C1 can purchase the restricted product based on the estimated age. The determination unit 11B determines an estimated age threshold (that is, the minor determination condition) for determining whether the restricted product can be purchased, based on the environment of the store that sells the restricted product or the situation of the customer.

Accordingly, the checkout system P1 according to the first embodiment can more adaptively perform the age estimation processing of the customer according to the environment of the store or the situation of the customer, and support the checkout of the restricted product by the customer.

As described above, in the checkout system P1 according to the first embodiment, the environment of the store includes the ratio of minors in the customer group using the store or the installation condition of the camera CM. Accordingly, the checkout system P1 according to the first embodiment can determine the threshold of the estimated age more suitable for determining whether the restricted product can be purchased (that is, the minor determination condition) based on the ratio of minors in the customer group using the store or the installation condition of the camera CM capturing the face image of the customer C1.

As described above, in the checkout system P1 according to the first embodiment, the situation of the customer C1 includes the degree of exposure of the face of the customer C1 appearing in the face image. Accordingly, the checkout system P1 according to the first embodiment can determine the threshold of the estimated age more suitable for determining whether the restricted product can be purchased (that is, the minor determination condition) based on the degree of exposure of the face of the customer based on the face image captured by the camera CM.

As described above, the determination unit 11B in the checkout system P1 according to the first embodiment determines that the customer can purchase the restricted product when it is determined that the estimated age is equal to or greater than the threshold. Accordingly, the checkout system P1 according to the first embodiment can execute the minor determination processing that is more suitable for the ratio of minors occupying the customer group using the store or the installation condition of the camera CM.

As described above, the determination unit 11B in the checkout system P1 according to the first embodiment determines whether the ratio of minors using the store is equal to or greater than the predetermined value, determines a first threshold (for example, the threshold H1 shown in FIG. 4) when it is determined that the ratio of minors is not equal to or greater than the predetermined value, and determines a second threshold (for example, any one of the thresholds H2 to H4 shown in FIG. 4) higher than the first threshold when it is determined that the ratio of minors is equal to or greater than the predetermined value. Accordingly, when the ratio of minors is equal to or greater than the predetermined value, the checkout system P1 according to the first embodiment can determine the threshold as the minor determination condition to be a higher estimated age, and can more effectively prevent the purchase of the restricted product due to the minor. Even when the age of the customer C1 is estimated to be higher than the actual age of the customer C1 as a result of the age estimation processing, the checkout system P1 can more efficiently prevent the purchase of the restricted product due to the minor by determining the threshold to be the higher estimated age.

As described above, the determination unit 11B in the checkout system P1 according to the first embodiment determines whether the installation condition of the camera CM satisfies the predetermined installation condition, determines the first threshold (for example, the threshold H1 shown in FIG. 4) when it is determined that the installation condition of the camera CM satisfies the predetermined installation condition, and determines the second threshold (for example, any one of the thresholds H2 to H4 shown in FIG. 4) higher than the first threshold when it is determined that the installation condition of the camera CM does not satisfy the predetermined installation condition. Accordingly, in the checkout system P1 according to the first embodiment, even when the face image captured by the camera CM is not suitable for the age estimation processing and the age of the customer C1 is estimated to be higher than the actual age of the customer C1 due to a decrease in the accuracy of the age estimation processing, it is possible to more efficiently prevent the purchase of the restricted product due to the minor.

As described above, the determination unit 11B in the checkout system P1 according to the first embodiment executes the determination of whether the ratio of minors using the store is equal to or greater than the predetermined value and the determination of whether the installation condition of the camera CM satisfies the predetermined installation condition, determines the first threshold (for example, the threshold H1 shown in FIG. 4) when it is determined that the ratio of minors is not equal to or greater than the predetermined value, determines the second threshold (for example, the threshold H2 shown in FIG. 4) higher than the first threshold when it is determined that the ratio of minors is equal to or greater than the predetermined value and the installation condition of the camera CM satisfies the predetermined installation condition, and determines a third threshold (for example, the threshold H3 or the threshold H4 shown in FIG. 4) higher than the second threshold when it is determined that the ratio of minors is equal to or greater than the predetermined value and the installation condition of the camera CM does not satisfy the predetermined installation condition. Accordingly, in the checkout system P1 according to the first embodiment, when the ratio of minors as the use condition of the store is equal to or greater than the predetermined value, the threshold of the estimated age can be determined to be higher in order to more efficiently prevent the purchase of the restricted product due to the minor. In the checkout system P1, even when the face image captured according to the installation condition of the camera CM is not suitable for the age estimation processing and the accuracy of the age estimation processing is reduced, the checkout system P1 can determine a higher estimated age threshold in order to more efficiently prevent the purchase of the restricted product due to the minor. Therefore, the checkout system P1 can determine the threshold more suitable for the use condition of the store and the installation condition of the camera CM as the minor determination condition.

As described above, the determination unit 11B in the checkout system P1 according to the first embodiment determines a processing time (that is, the estimated time) of the age estimation processing of the customer C1 by the determination unit 11B based on the environment of the store or the situation of the customer Ci. Accordingly, the checkout system P1 according to the first embodiment can more effectively adjust the age estimation accuracy of the customer C1 based on the face image by adaptively determining the estimated time based on the environment of the store or the situation of the customer C1.

As described above, the determination unit 11B in the checkout system P1 according to the first embodiment determines whether the ratio of minors using the store is equal to or greater than the predetermined value, determines the processing time to be a first processing time (for example, the estimated time T1 shown in FIG. 5) when it is determined that the ratio of minors is not equal to or greater than the predetermined value, and determines the processing time to be a second processing time (for example, any of the estimated times T2 to T4 shown in FIG. 5) longer than the first processing time when it is determined that the ratio of minors is equal to or greater than the predetermined value. Accordingly, when the ratio of minors using the store is equal to or greater than the predetermined value, the checkout system P1 according to the first embodiment can determine the estimated time of the age estimation processing to be a longer period of time, improve the accuracy of the age estimation processing of the customer C1 based on the face image, and more effectively prevent the purchase of the restricted product due to the minor.

As described above, the determination unit 11B in the checkout system P1 according to the first embodiment determines whether the installation condition of the camera CM satisfies the predetermined installation condition, determines the first processing time (for example, the estimated time T1 shown in FIG. 5) when it is determined that the installation condition of the camera CM satisfies the predetermined installation condition, and determines the second processing time (for example, any one of the estimated times T2 to T4 shown in FIG. 5) longer than the first processing time when it is determined that the installation condition of the camera CM does not satisfy the predetermined installation condition. Accordingly, even when the installation condition of the camera CM does not satisfy the predetermined installation condition and the age estimation is executed based on the face image which is not suitable for the age estimation processing, the checkout system P1 according to the first embodiment can improve the accuracy of the age estimation processing of the customer C1 based on the face image by determining the estimated time of the age estimation processing to be a longer period of time.

As described above, the determination unit 11B in the checkout system P1 according to the first embodiment executes the determination of whether the ratio of minors using the store is equal to or greater than the predetermined value and the determination of whether the installation condition of the camera CM satisfies the predetermined installation condition, determines the first processing time (for example, the estimated time T1 shown in FIG. 5) when it is determined that the ratio of minors is not equal to or greater than the predetermined value, determines the second processing time (for example, the estimated time T2 shown in FIG. 5) longer than the first processing time when it is determined that the ratio of minors is equal to or greater than the predetermined value and the installation condition of the camera CM satisfies the predetermined installation condition, and determines a third processing time (for example, the estimated time T3 or the estimated time T4 shown in FIG. 5) longer than the second processing time when it is determined that the ratio of minors is equal to or greater than the predetermined value and the installation condition of the camera CM does not satisfy the predetermined installation condition. Accordingly, when the ratio of minors using the store is equal to or greater than the predetermined value, the checkout system P1 according to the first embodiment can determine the estimated time of the age estimation processing to be a longer period of time, improve the accuracy of the age estimation processing of the customer C1 based on the face image, and more effectively prevent the purchase of the restricted product due to the minor. Even when the installation condition of the camera CM does not satisfy the predetermined installation condition and the age estimation is executed based on the face image which is not suitable for the age estimation processing, the checkout system P1 can improve the accuracy of the age estimation processing of the customer C1 based on the face image by determining the estimated time of the age estimation processing to be the longer period of time.

As described above, the checkout system P1 according to the first embodiment further includes the communication unit 10 (an example of an acquisition unit) capable of acquiring the surrounding information of the store. The determination unit 11B determines whether the ratio of minors using the store is equal to or greater than the predetermined value based on the surrounding information of the store acquired by the communication unit 10. Accordingly, the checkout system P1 according to the first embodiment can determine whether the ratio of minors using the store is equal to or greater than the predetermined value based on the surrounding information of the store, regardless of the ratio of actual minors using the store.

As described above, the communication unit 10 in the checkout system P1 according to the first embodiment acquires event information held around the store. The determination unit 11B determines whether the ratio of minors using the store is equal to or greater than the predetermined value based on the event information acquired by the communication unit 10. Accordingly, the checkout system P1 according to the first embodiment can determine in advance whether the ratio of minors using the store is used is equal to or greater than the predetermined value based on the event information held around the store, regardless of the ratio of actual minors using the store.

As described above, the determination unit 11B in the checkout system P1 according to the first embodiment determines whether the installation condition of the camera CM satisfies the predetermined installation condition based on the image quality of the face image. Accordingly, the checkout system P1 according to the first embodiment can determine whether the accuracy of the age estimation processing may be decreased due to the deterioration of the image quality of the face image captured by the camera CM.

As described above, the determination unit 11B in the checkout system P1 according to the first embodiment determines whether the installation condition of the camera CM satisfies the predetermined installation condition based on the direction of the face of the customer appearing in the face image. Accordingly, the checkout system P1 according to the first embodiment can determine whether the accuracy of the age estimation processing may be decreased based on whether the direction of the face of the customer C1 appearing in the face image captured by the camera CM is other than the front direction.

As described above, the determination unit 11B in the checkout system P1 according to the first embodiment determines the threshold of the estimated age for determining whether the restricted product can be purchased based on at least one of whether the customer C1 appearing in the face image wears the mask, whether the customer C1 wears the sunglasses, and whether the customer C1 wears the hat. Accordingly, the checkout system P1 according to the first embodiment can more effectively adjust the age estimation accuracy of the customer C1 based on the face image by adaptively determining the estimated time even when the age estimation is executed based on the face image in which a part of the face is hidden and which is not suitable for the age estimation processing.

Although the various embodiments are described above with reference to the drawings, it is needless to say that the present disclosure is not limited to such examples. It will be apparent to those skilled in the art that various changes, modifications, substitutions, additions, deletions, and equivalents can be conceived within the scope of the claims, and it should be understood that such changes and the like also belong to the technical scope of the present disclosure. Components in the various embodiments mentioned above may be combined optionally in the range without deviating from the scope of the invention.

The present disclosure is useful as a checkout system and a checkout method that support checkout of a restricted product by a customer by more adaptively performing age estimation processing of the customer according to an environment of a store or a situation of the customer.

1. A checkout system implemented by one or more computers, the checkout system comprising:
a product detection unit configured to detect a product to be purchased;
a detection unit configured to detect whether the product detected by the product detection unit is a restricted product;
a camera configured to capture a face image of a customer in a case in which the restricted product is detected by the detection unit;
an age estimation unit configured to perform age estimation processing of the customer based on the face image captured by the camera; and
a determination unit configured to determine whether the customer is allowed to purchase the restricted product based on an estimated age,
wherein the determination unit determines a threshold of the estimated age for determining whether the restricted product is allowed to be purchased based on an environment of a store that sells the restricted product or a situation of the customer.

2. The checkout system according to claim 1,
wherein the environment of the store comprises at least one of: a ratio of minors in a customer group using the store; and an installation condition of the camera.

3. The checkout system according to claim 1,
wherein the situation of the customer comprises a degree of exposure of a face of the customer appearing in the face image.

4. The checkout system according to claim 1,
wherein the determination unit is configured to determine that the customer is allowed to purchase the restricted product in a case in which the determination unit determines that the estimated age is equal to or greater than the threshold.

5. The checkout system according to claim 2,
wherein the determination unit is configured to:
determine whether the ratio of minors using the store is equal to or greater than a predetermined value;
determine the threshold to be a first threshold in a case in which the determination unit determines that the ratio of minors is not equal to or greater than the predetermined value; and
determine the threshold to be a second threshold higher than the first threshold in a case in which the determination unit determines that the ratio of minors is equal to or greater than the predetermined value.

6. The checkout system according to claim 2,
wherein the determination unit is configured to:
determine whether the installation condition of the camera satisfies a predetermined installation condition;
determine the threshold to be a first threshold in a case in which the determination unit determines that the installation condition of the camera satisfies the predetermined installation condition; and
determine the threshold to be a second threshold higher than the first threshold in a case in which the determination unit determines that the installation condition of the camera does not satisfy the predetermined installation condition.

7. The checkout system according to claim 2,
wherein the determination unit is configured to:
execute determination as to whether the ratio of minors using the store is equal to or higher than a predetermined value and determination as to whether the installation condition of the camera satisfies a predetermined installation condition;
determine the threshold to be a first threshold in a case in which the determination unit determines that the ratio of minors is not equal to or greater than the predetermined value;
determine the threshold to be a second threshold higher than the first threshold in a case in which the determination unit determines that the ratio of the minors is equal to or higher than the predetermined value and the installation condition of the camera satisfies the predetermined installation condition; and
determine the threshold as a third threshold higher than the second threshold in a case in which the determination unit determines that the ratio of the minors is equal to or higher than the predetermined value and the installation condition of the camera does not satisfy the predetermined installation condition.

8. The checkout system according to claim 1,
wherein the determination unit is configured to determine a processing time of the age estimation processing of the customer by the age estimation unit based on the environment of the store or the situation of the customer.

9. The checkout system according to claim 8,
wherein the determination unit is configured to:
determine whether a ratio of minors using the store as the environment of the store is equal to or greater than the predetermined value based on a use condition of the store;
determine the processing time to be a first processing time in a case in which the determination unit determines that the ratio of minors is not equal to or greater than the predetermined value; and
determine the processing time to be a second processing time longer than the first processing time in a case in which the determination unit determines that the ratio of minors is equal to or greater than the predetermined value.

10. The checkout system according to claim 8,
wherein the determination unit is configured to:
determine whether an installation condition of the camera as the environment of the store satisfies the predetermined installation condition;
determine the processing time to be a first processing time in a case in which the determination unit determines that the installation condition of the camera satisfies the predetermined installation condition; and
determine the processing time to be a second processing time longer than the first processing time in a case in which the determination unit determines that the installation condition of the camera does not satisfy the predetermined installation condition.

11. The checkout system according to claim 8,
wherein the determination unit is configured to:
execute determination as to whether a ratio of minors using the store as the environment of the store is equal to or higher than a predetermined value and determination as to whether an installation condition of the camera as the environment of the store satisfies a predetermined installation condition;
determine a processing time to be a first processing time in a case in which the determination unit determines that the ratio of minors is not equal to or greater than the predetermined value;
determine the processing time to be a second processing time longer than the first processing time in a case in which the determination unit determines that the ratio of the minors is equal to or higher than the predetermined value and the installation condition of the camera satisfies the predetermined installation condition; and
determine the processing time to be a third processing time longer than the second processing time when in a case in which the determination unit determines that the ratio of the minors is equal to or higher than the predetermined value and the installation condition of the camera does not satisfy the predetermined installation condition.

12. The checkout system according to claim 5, further comprising:
an acquisition unit configured to acquire surrounding information of the store,
wherein the determination unit is configured to determine whether the ratio of minors using the store is equal to or greater than the predetermined value based on the surrounding information of the store acquired by the acquisition unit.

13. The checkout system according to claim 12,
wherein the acquisition unit is configured to acquire event information held around the store, and
wherein the determination unit is configured to determine whether the ratio of minors using the store is equal to or greater than the predetermined value based on the event information acquired by the acquisition unit.

14. The checkout system according to claim 2,
wherein the determination unit is configured to determine whether the installation condition of the camera satisfies a predetermined installation condition based on image quality of the face image.

15. The checkout system according to claim 1,
wherein the determination unit is configured to determine whether an installation condition of the camera as the environment of the store satisfies a predetermined installation condition based on a direction of the face of the customer appearing in the face image.

16. The checkout system according to claim 3,
wherein the determination unit is configured to determine the threshold of the estimated age for determining whether the restricted product is allowed to be purchased based on at least one of whether the customer appearing in the face image wears a mask, whether the customer wears sunglasses, and whether the customer wears a hat.

17. A checkout method implemented by one or more computers, the checkout method comprising:
detecting a product to be purchased;
detecting whether the product is a restricted product;
capturing a face image of a customer in a case in which the restricted product is detected;
performing age estimation processing of the customer based on the captured face image;
determining whether the customer is allowed to purchase the restricted product based on the estimated age estimated; and
determining a threshold of the estimated age for determining whether the restricted product is allowed to purchased based on an environment of a store that sells the restricted product or a situation of the customer.
